(19) United States
(12) Patent Application Publication
(10) Pub. No.: US 2015/0081349 A1
(43) Pub. Date: Mar. 19, 2015

(54) Systems and Methods to Provide Location Indication in Transaction Data

(71) Applicant: Visa International Service Association, San Francisco, CA (US)

(72) Inventors: Colette Michele Johndrow, San Francisco, CA (US); Zhongxiao Jiang, San Jose, CA (US); Sara A. Brumbaugh, Redwood City, CA (US); Michael West, San Francisco, CA (US); Chad William Zucker, Oakland, CA (US); Todd McGregor, Danville, CA (US)

(21) Appl. No.: 14/484,727

(22) Filed: Sep. 12, 2014

Related U.S. Application Data
(60) Provisional application No. 61/877,846, filed on Sep. 13, 2013.

(51) Int. Cl. G06Q 10/02; G06Q 20/10; G06Q 20/40

(52) U.S. Cl. CPC G06Q 10/02; G06Q 20/40; G06Q 20/10
USPC 705/5

(57) ABSTRACT

A computing apparatus configured to: receive an authorization request for a payment transaction initiated in a transaction terminal; determine whether a location of the transaction terminal is in a travel region of the user in accordance with travel information of the user; and provide an indicator in the authorization request transmitted to an issuer processor in accordance with a result of the determination of whether the location of the transaction terminal is in the travel region of the user.

### RELATED APPLICATIONS

The present application claims the benefit of the filing date of Prov. U.S. Pat. App. Ser. No. 61/877,846, filed Sep. 13, 2013 and entitled “Systems and Methods to Provide Location Indication in Transaction Data”, the entire disclosure of which is hereby incorporated herein by reference.

### FIELD OF THE TECHNOLOGY

At least some embodiments of the present disclosure relate to programming operations to be performed by computing apparatuses in general, and more particularly, but not limited to, programming operations, such as information delivery and processing, based on the processing of transaction data, such as records of payments made via credit cards, debit cards, prepaid cards, etc.

### BACKGROUND

Millions of transactions occur daily through the use of payment cards, such as credit cards, debit cards, prepaid cards, etc. Corresponding records of the transactions are recorded in databases for settlement and financial record keeping (e.g., to meet the requirements of government regulations). Such data can be mined and analyzed for trends, statistics, and other analyses. Sometimes such data are mined for specific advertising goals, such as to provide targeted offers to account holders, as described in PCT Pub. No. WO 2008/067543 A2, published on Jun. 5, 2008 and entitled “Techniques for Targeted Offers.”

U.S. Pat. App. Pub. No. 2009/0216579, published on Aug. 27, 2009 and entitled “Tracking Online Advertising using Payment Services,” discloses a system in which a payment service identifies the activity of a user using a payment card as corresponding with an offer associated with an online advertisement presented to the user.

U.S. Pat. No. 6,298,330, issued on Oct. 2, 2001 and entitled “Communicating with a Computer Based on the Offline Purchase History of a Particular Consumer,” discloses a system in which a targeted advertisement is delivered to a computer in response to receiving an identifier, such as a cookie, corresponding to the computer.

U.S. Pat. No. 7,035,855, issued on Apr. 25, 2006 and entitled “Process and System for Integrating Information from Disparate Databases for Purposes of Predicting Consumer Behavior,” discloses a system in which consumer transactional information is used for predicting consumer behavior.

U.S. Pat. No. 6,505,168, issued on Jan. 7, 2003 and entitled “System and Method for Gathering and Standardizing Customer Purchase Information for Target Marketing,” discloses a system in which categories and sub-categories are used to organize purchasing information by credit cards, debit cards, checks and the like. The customer purchase information is used to generate customer preference information for making targeted offers.

U.S. Pat. No. 7,444,658, issued on Oct. 28, 2008 and entitled “Method and System to Perform Content Targeting,” discloses a system in which advertisements are selected to be sent to users based on a user classification performed using credit card purchasing data.

U.S. Pat. App. Pub. No. 2005/0055275, published on Mar. 10, 2005 and entitled “System and Method for Analyzing Marketing Efforts,” discloses a system that evaluates the cause and effect of advertising and marketing programs using card transaction data.

U.S. Pat. App. Pub. No. 2008/0217397, published on Sep. 11, 2008 and entitled “Real-Time Awards Determinations,” discloses a system for facilitating transactions with real-time awards determinations for a cardholder, in which the award may be provided to the cardholder as a credit on the cardholder's statement.

The disclosures of the above discussed patent documents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 illustrates a system to provide services based on transaction data according to one embodiment.

FIG. 2 illustrates the generation of an aggregated spending profile according to one embodiment.

FIG. 3 shows a method to generate an aggregated spending profile according to one embodiment.

FIG. 4 shows a system to provide information based on transaction data according to one embodiment.

FIG. 5 illustrates a transaction terminal according to one embodiment.

FIG. 6 illustrates an account identifying device according to one embodiment.

FIG. 7 illustrates a data processing system according to one embodiment.

FIG. 8 shows the structure of account data for providing loyalty programs according to one embodiment.

FIG. 9 shows a system to provide real-time messages according to one embodiment.

FIG. 10 shows a method to provide real-time messages according to one embodiment.

FIG. 11 shows a method to provide benefits according to one embodiment.

FIG. 12 illustrates an integrated system for social networking check-in and for payment processing according to one embodiment.

FIG. 13 shows a method for check-in authentication or verification according to one embodiment.

FIG. 14 shows a method to provide a check-in reward according to one embodiment.

FIG. 15 shows a method for social networking check-in according to one embodiment.

FIG. 16 shows a method to provide offers based on social networking check-in according to one embodiment.

FIG. 17 shows a method to combine check-in information and transaction locations according to one embodiment.

FIG. 18 shows a system to transmit location information in an authorization request according to one embodiment.

FIG. 19 shows a method to transmit location information in an authorization request according to one embodiment.

### DETAILED DESCRIPTION

### Introduction

The transaction data, such as records of transactions made via credit accounts, debit accounts, prepaid accounts, bank accounts, stored value accounts and the like, can be further processed to optionally provide information for various services, such as reporting, benchmarking, advertising, content or offer selection, customization, personalization, prioritization, etc. In one embodiment of improving privacy protections, users are required to enroll in a service program and provide consent to allow the system to use related transaction data and/or other data for the related services, and the system is configured to provide the services while protecting the privacy of the users in accordance with the enrollment agreement and user consent.

For example, based on the transaction data, an advertising network in one embodiment is provided to present personalized or targeted advertisements/offers on behalf of advertisers. A computing apparatus of, or associated with, the transaction handler uses the transaction data and/or other data, such as account data, merchant data, search data, social networking data, web data, etc., to develop intelligence information about individual customers, or certain types or groups of customers. The intelligence information can be used to select, identify, generate, adjust, prioritize, and/or personalize advertisements/offers to the customers. The transaction handler may be further automated to process the advertisement fees charged to the advertisers, using the accounts of the advertisers, in response to the advertising activities.

For example, the computing apparatus can be configured to generate trigger records for a transaction handler to identify authorization requests that satisfy the conditions specified in the trigger records, identify communication references of the users associated with the identified authorization requests, and use the communication references to target real-time messages at the users in parallel with the transaction handler providing responses to the respective authorization requests. Details in one embodiment regarding the generation and delivery of messages in real-time with the processing of transactions are provided in the section entitled “REAL-TIME MESSAGES.”

In one embodiment, a user member of a social network, such as Facebook, can utilize the social network check-in functionality; and the transaction handler, via a communication network, can receive a social network system check-in notice identifying the user, a user portable communication device and a check-in location. The correlator can identify an account of the user using information such as account data and social network participant data. The correlator can then match a transaction in the account of the user (e.g., to a point of sale device at the location of the check-in) to authenticate the check-in and to keep an audit record of the check-ins. The check-in authentication can also be utilized to provide real-time messages (e.g., targeted advertising), to validate a check-in reward issued by the merchant proprietor of the location and/or the social network, to calculate and deliver loyalty program awards for an authenticated check-in, etc. The correlation can also be used to detect inaccurate data about the location and/or the merchant associated with the transaction terminals. Details and examples in one embodiment are provided in the section entitled “CHECK-IN.”

In one embodiment, a location indicator is provided in an authorization request to assist a payment processor, such as an issuer processor of a payment account in determining whether or not to authorize a payment transaction in the payment account, where the payment transaction is initiated at a transaction terminal located outside the home region of the user of the payment account. For example, a tag can be provided in an authorization request to indicate that the user of a payment account is traveling; and the location of the transaction terminal is consistent with the region in which the user is traveling. Further details and examples in one embodiment are provided in the section entitled “TRAVEL TAG.”

In one embodiment, the computing apparatus correlates transactions with activities that occurred outside the context of the transaction, such as online advertisements presented to the customers that at least in part cause offline transactions. The correlation data can be used to demonstrate the success of the advertisements, and/or to improve intelligence information about how individual customers and/or various types or groups of customers respond to the advertisements.

In one embodiment, the computing apparatus correlates, or provides information to facilitate the correlation of, transactions with online activities of the customers, such as searching, web browsing, social networking and consuming advertisements, with other activities, such as watching television programs, and/or with events, such as meetings, announcements, natural disasters, accidents, news announcements, etc.

In one embodiment, the correlation results are used in predictive models to predict transactions and/or spending patterns based on activities or events, to predict activities or events based on transactions or spending patterns, to provide alerts or reports, etc.

In one embodiment, a single entity operating the transaction handler performs various operations in the services provided based on the transaction data. For example, in the presentation of the personalized or targeted advertisements, the single entity may perform the operations such as generating the intelligence information, selecting relevant intelligence information for a given audience, selecting, identifying, adjusting, prioritizing, personalizing and/or generating advertisements based on selected relevant intelligence information, and facilitating the delivery of personalized or targeted advertisements, etc. Alternatively, the entity operating the transaction handler cooperates with one or more other entities by providing information to these entities to allow these entities to perform at least some of the operations for presentation of the personalized or targeted advertisements.

### Transaction Data Based Services

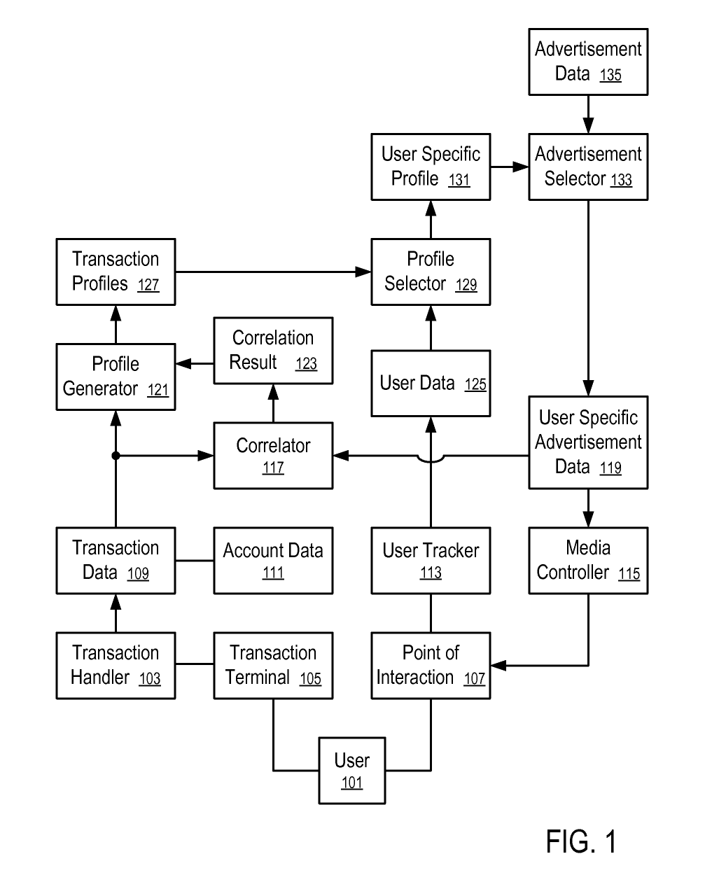

FIG. 1 illustrates a system to provide services based on transaction data according to one embodiment. In FIG. 1, the system includes a transaction terminal (105) to initiate financial transactions for a user (101), a transaction handler (103) to generate transaction data (109) from processing the financial transactions of the user (101) (and the financial transactions of other users), a profile generator (121) to generate transaction profiles (127) based on the transaction data (109) to provide information/intelligence about user preferences and spending patterns, a point of interaction (107) to provide information and/or offers to the user (101), a user tracker (113) to generate user data (125) to identify the user (101) using the point of interaction (107), a profile selector (129) to select a profile (131) specific to the user (101) identified by the user data (125), and an advertisement selector (133) to select, identify, generate, adjust, prioritize and/or personalize advertisements for presentation to the user (101) on the point of interaction (107) via a media controller (115).

In FIG. 1, the system further includes a correlator (117) to correlate user specific advertisement data (119) with transactions resulting from the user specific advertisement data (119). The correlation results (123) can be used by the profile generator (121) to improve the transaction profiles (127).

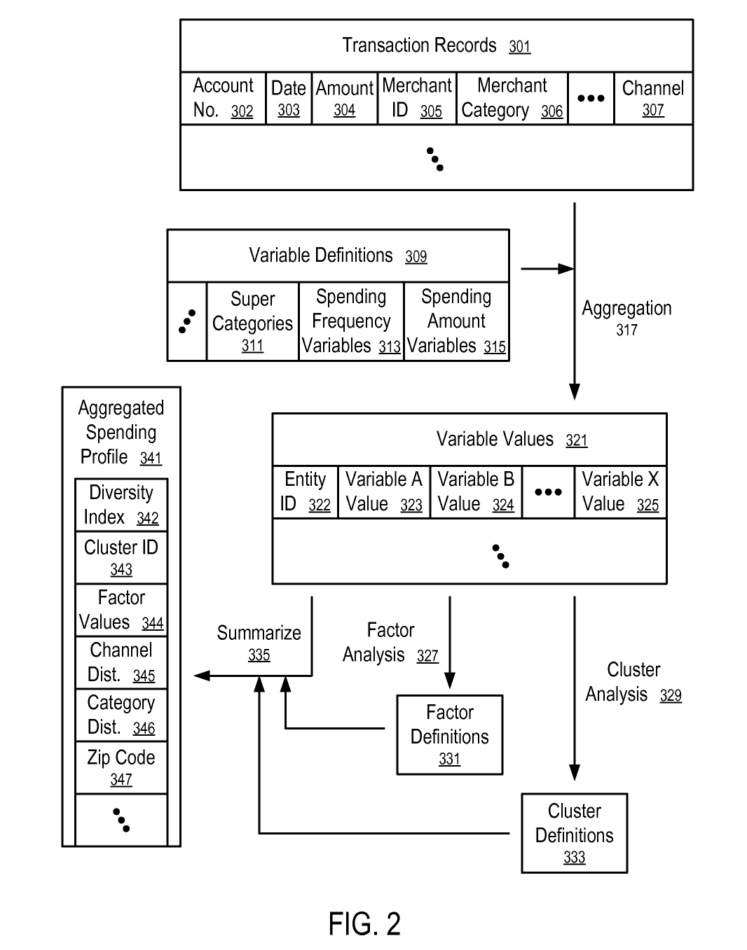

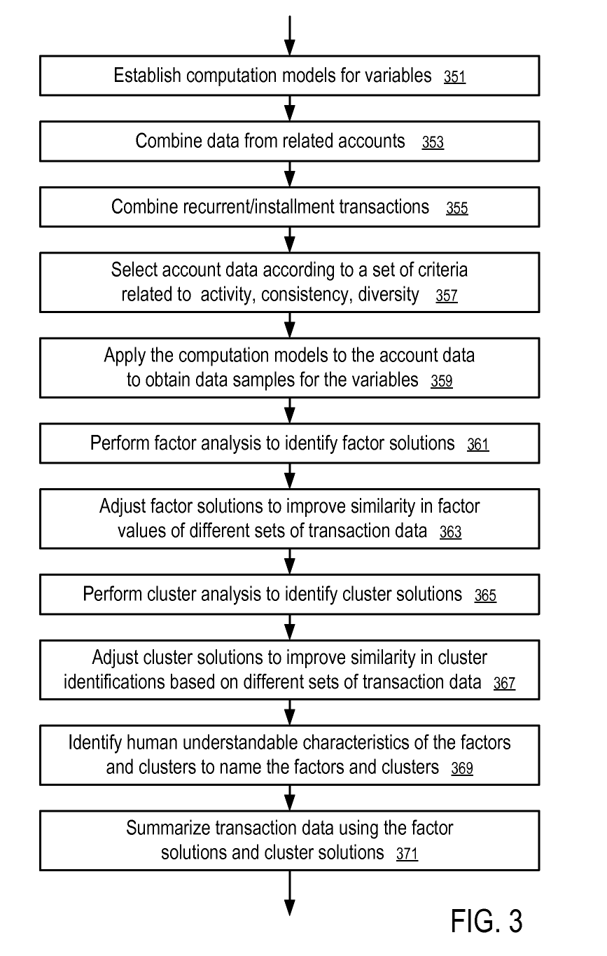

The transaction profiles (127) of one embodiment are generated from the transaction data (109) in a way as illustrated in FIGS. 2 and 3. For example, in FIG. 2, an aggregated spending profile (341) is generated via the factor analysis (327) and cluster analysis (329) to summarize (335) the spending patterns/behaviors reflected in the transaction records (301).

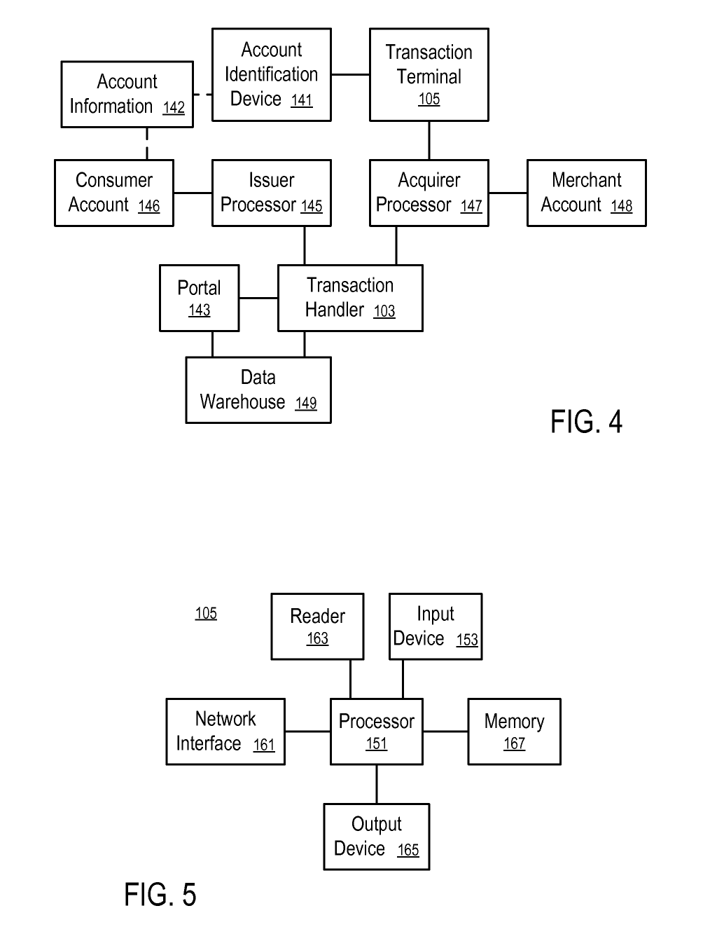

In one embodiment, a data warehouse (149) as illustrated in FIG. 4 is coupled with the transaction handler (103) to store the transaction data (109) and other data, such as account data (111), transaction profiles (127) and correlation results (123). In FIG. 4, a portal (143) is coupled with the data warehouse (149) to provide data or information derived from the transaction data (109), in response to a query request from a third party or as an alert or notification message.

In FIG. 4, the transaction handler (103) is coupled between an issuer processor (145) in control of a consumer account (146) and an acquirer processor (147) in control of a merchant account (148). An account identification device (141) is configured to carry the account information (142) that identifies the consumer account (146) with the issuer processor (145) and provide the account information (142) to the transaction terminal (105) of a merchant to initiate a transaction between the user (101) and the merchant.

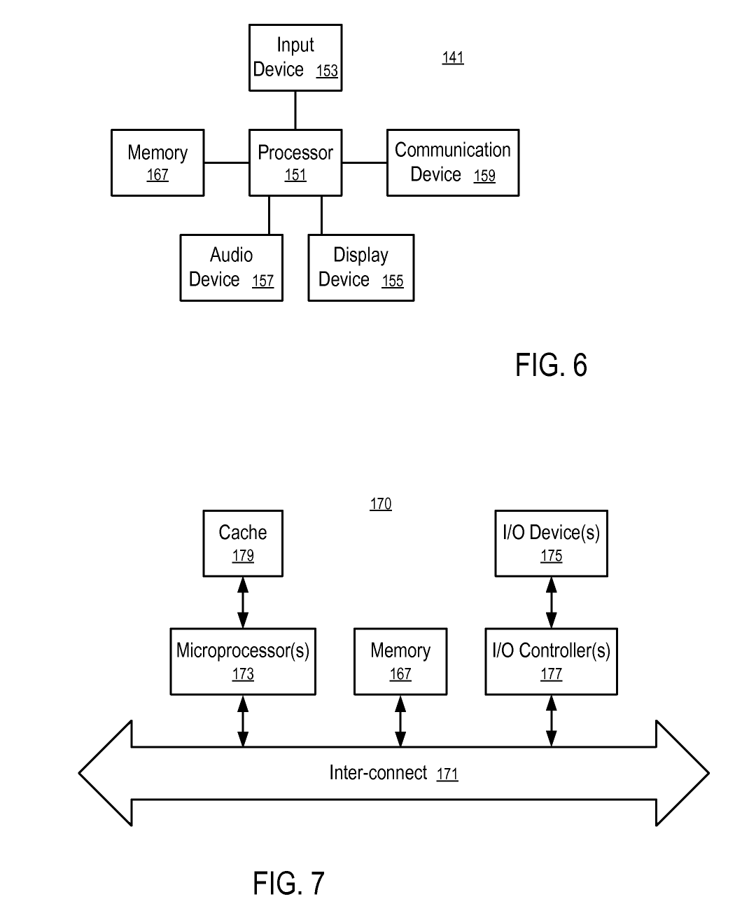

FIGS. 5 and 6 illustrate examples of transaction terminals (105) and account identification devices (141). FIG. 7 illustrates the structure of a data processing system (170) that can be used to implement, with more or fewer elements, at least some of the components in the system, such as the point of interaction (107), the transaction handler (103), the portal (143), the data warehouse, the account identification device (141), the transaction terminal (105), the user tracker (113), the profile generator (121), the profile selector (129), the advertisement selector (133), the media controller (115), etc. Some embodiments use more or fewer components than those illustrated, such as, in FIGS. 1, 4-7, and other figures, as further discussed in the section entitled “VARIATIONS.”

In one embodiment, the transaction data (109) relates to financial transactions processed by the transaction handler (103); and the account data (111) relates to information about the account holders involved in the transactions. Further data, such as merchant data that relates to the location, business, products and/or services of the merchants that receive payments from account holders for their purchases, can be used in the generation of the transaction profiles (127, 341).

In one embodiment, the financial transactions are made via an account identification device (141), such as financial transaction cards (e.g., credit cards, debit cards, banking cards, etc.); the financial transaction cards may be embodied in various devices, such as plastic cards, chips, radio frequency identification (RFID) devices, mobile phones, personal digital assistants (PDAs), etc.; and the financial transaction cards may be represented by account identifiers (e.g., account numbers or aliases). In one embodiment, the financial transactions are made via directly using the account information (142), without physically presenting the account identification device (141).

Further features, modifications and details are provided in various sections of this description.

### Centralized Data Warehouse

In one embodiment, the transaction handler (103) couples with a centralized data warehouse (149) organized around the transaction data (109). For example, the centralized data warehouse (149) may include, and/or support the determination of, spend band distribution, transaction count and amount, merchant categories, merchant by state, cardholder segmentation by velocity scores, and spending within merchant target, competitive set and cross-section. For example, the centralized data warehouse (149) may include the advertisement data (135) and/or offers of benefits such as discount, reward, points, cashback, etc. The offers can be communicated to the users (e.g., 101) via the advertisement data (135) or as part of the advertisement data (135).

In one embodiment, the centralized data warehouse (149) provides centralized management but allows decentralized execution. For example, a third party strategic marketing analyst, statistician, marketer, promoter, business leader, etc., may access the centralized data warehouse (149) to analyze customer and shopper data, to provide follow-up analyses of customer contributions, to develop propensity models for increased conversion of marketing campaigns, to develop segmentation models for marketing, etc. The centralized data warehouse (149) can be used to manage advertisement campaigns and analyze response profitability.

In one embodiment, the centralized data warehouse (149) includes merchant data (e.g., data about sellers), customer/business data (e.g., data about buyers), and transaction records (301) between sellers and buyers over time. The centralized data warehouse (149) can be used to support corporate sales forecasting, fraud analysis reporting, sales/customer relationship management (CRM) business intelligence, credit risk prediction and analysis, advanced authorization reporting, merchant benchmarking, business intelligence for small business, rewards, etc.

In one embodiment, the transaction data (109) is combined with external data, such as surveys, benchmarks, search engine statistics, demographics, competition information, emails, etc., to flag key events and data values, to set customer, merchant, data or event triggers, and to drive new transactions and new customer contacts.

### Transaction Profile

In FIG. 1, the profile generator (121) generates transaction profiles (127) based on the transaction data (109), the account data (111), and/or other data, such as non-transactional data, wish lists, merchant provided information, address information, information from social network websites, information from credit bureaus, information from search engines, and other examples discussed in U.S. Pat. App. Pub. No. 2011/0054981, entitled “Analyzing Local Non-Transactional Data with Transactional Data in Predictive Models,” the disclosure of which is hereby incorporated herein by reference.

In one embodiment, the transaction profiles (127) provide intelligence information on the behavior, pattern, preference, propensity, tendency, frequency, trend, and budget of the user (101) in making purchases. In one embodiment, the transaction profiles (127) include information about what the user (101) owns, such as points, miles, or other rewards currency, available credit, and received offers, such as coupons loaded into the accounts of the user (101). In one embodiment, the transaction profiles (127) include information based on past offer/coupon redemption patterns. In one embodiment, the transaction profiles (127) include information on shopping patterns in retail stores as well as online, including frequency of shopping, amount spent in each shopping trip, distance of merchant location (retail) from the address of the account holder(s), etc.

In one embodiment, the transaction handler (103) (and/or the portal (143)) is configured to provide at least part of the intelligence for the prioritization, generation, selection, customization and/or adjustment of the advertisement for delivery within a transaction process involving the transaction handler (103). For example, the advertisement may be presented to a customer in response to the customer making a payment via the transaction handler (103).

Some of the transaction profiles (127) are specific to the user (101), or to an account of the user (101), or to a group of users of which the user (101) is a member, such as a household, family, company, neighborhood, city, or group identified by certain characteristics related to online activities, offline purchase activities, merchant propensity, etc.

The profile generator (121) may generate and update the transaction profiles (127) in batch mode periodically, or generates the transaction profiles (127) in real time, or just in time, in response to a request received in the portal (143) for such profiles.

The transaction profiles (127) of one embodiment include the values for a set of parameters. Computing the values of the parameters may involve counting transactions that meet one or more criteria, and/or building a statistically-based model in which one or more calculated values or transformed values are put into a statistical algorithm that weights each value to optimize its collective predictiveness for various predetermined purposes.

Further details and examples about the transaction profiles (127) in one embodiment are provided in the section entitled “AGGREGATED SPENDING PROFILE.”

### Non-Transactional Data

In one embodiment, the transaction data (109) is analyzed in connection with non-transactional data to generate transaction profiles (127) and/or to make predictive models.

In one embodiment, transactions are correlated with non-transactional events, such as news, conferences, shows, announcements, market changes, natural disasters, etc. to establish cause and effect relations to predict future transactions or spending patterns. For example, non-transactional data may include the geographic location of a news event, the date of an event from an events calendar, the name of a performer for an upcoming concert, etc. The non-transactional data can be obtained from various sources, such as newspapers, websites, blogs, social networking sites, etc.

When the cause and effect relationships between the transactions and non-transactional events are known (e.g., based on prior research results, domain knowledge, expertise), the relationships can be used in predictive models to predict future transactions or spending patterns, based on events that occurred recently or are happening in real time.

In one embodiment, the non-transactional data relates to events that happened in a geographical area local to the user (101) that performed the respective transactions. In one embodiment, a geographical area is local to the user (101) when the distance from the user (101) to locations in the geographical area is within a convenient range for daily or regular travel, such as 20, 50 or 100 miles from an address of the user (101), or within the same city or zip code area of an address of the user (101). Examples of analyses of local non-transactional data in connection with transaction data (109) in one embodiment are provided in U.S. Pat. App. Pub. No. 2011/0054981, entitled “Analyzing Local Non-Transactional Data with Transactional Data in Predictive Models,” the disclosure of which is hereby incorporated herein by reference.

In one embodiment, the non-transactional data is not limited to local non-transactional data. For example, national non-transactional data can also be used.

In one embodiment, the transaction records (301) are analyzed in frequency domain to identify periodic features in spending events. The periodic features in the past transaction records (301) can be used to predict the probability of a time window in which a similar transaction would occur. For example, the analysis of the transaction data (109) can be used to predict when a next transaction having the periodic feature would occur, with which merchant, the probability of a repeated transaction with a certain amount, the probability of exception, the opportunity to provide an advertisement or offer such as a coupon, etc. In one embodiment, the periodic features are detected through counting the number of occurrences of pairs of transactions that occurred within a set of predetermined time intervals and separating the transaction pairs based on the time intervals. Some examples and techniques for the prediction of future transactions based on the detection of periodic features in one embodiment are provided in U.S. Pat. App. Pub. No. 2010/0280882, entitled “Frequency-Based Transaction Prediction and Processing,” the disclosure of which is hereby incorporated herein by reference.

Techniques and details of predictive modeling in one embodiment are provided in U.S. Pat. Nos. 6,119,103, 6,018,723, 6,658,393, 6,598,030, and 7,227,950, the disclosures of which are hereby incorporated herein by reference.

In one embodiment, offers are based on the point-of-service to offeree distance to allow the user (101) to obtain in-person services. In one embodiment, the offers are selected based on transaction history and shopping patterns in the transaction data (109) and/or the distance between the user (101) and the merchant. In one embodiment, offers are provided in response to a request from the user (101), or in response to a detection of the location of the user (101). Examples and details of at least one embodiment are provided in U.S. Pat. App. Pub. No. 2008/0319843, entitled “Supply of Requested Offer Based on Point-of Service to Offeree Distance,” U.S. Pat. App. Pub. No. 2008/0300973, entitled “Supply of Requested Offer Based on Offeree Transaction History,” U.S. Pat. App. Pub. No. 2009/0076896, entitled “Merchant Supplied Offer to a Consumer within a Predetermined Distance,” U.S. Pat. App. Pub. No. 2009/0076925, entitled “Offeree Requested Offer Based on Point-of Service to Offeree Distance,” and U.S. Pat. Pub. No. 2010/0274627, entitled “Receiving an Announcement Triggered by Location Data,” the disclosures of which applications are hereby incorporated herein by reference.

### Targeting Advertisement

In FIG. 1, an advertisement selector (133) prioritizes, generates, selects, adjusts, and/or customizes the available advertisement data (135) to provide user specific advertisement data (119) based at least in part on the user specific profile (131). The advertisement selector (133) uses the user specific profile (131) as a filter and/or a set of criteria to generate, identify, select and/or prioritize advertisement data for the user (101). A media controller (115) delivers the user specific advertisement data (119) to the point of interaction (107) for presentation to the user (101) as the targeted and/or personalized advertisement.

In one embodiment, the user data (125) includes the characterization of the context at the point of interaction (107). Thus, the use of the user specific profile (131), selected using the user data (125), includes the consideration of the context at the point of interaction (107) in selecting the user specific advertisement data (119).

In one embodiment, in selecting the user specific advertisement data (119), the advertisement selector (133) uses not only the user specific profile (131), but also information regarding the context at the point of interaction (107). For example, in one embodiment, the user data (125) includes information regarding the context at the point of interaction (107); and the advertisement selector (133) explicitly uses the context information in the generation or selection of the user specific advertisement data (119).

In one embodiment, the advertisement selector (133) may query for specific information regarding the user (101) before providing the user specific advertisement data (119). The queries may be communicated to the operator of the transaction handler (103) and, in particular, to the transaction handler (103) or the profile generator (121). For example, the queries from the advertisement selector (133) may be transmitted and received in accordance with an application programming interface or other query interface of the transaction handler (103), the profile generator (121) or the portal (143) of the transaction handler (103).

In one embodiment, the queries communicated from the advertisement selector (133) may request intelligence information regarding the user (101) at any level of specificity (e.g., segment level, individual level). For example, the queries may include a request for a certain field or type of information in a cardholder's aggregate spending profile (341). As another example, the queries may include a request for the spending level of the user (101) in a certain merchant category over a prior time period (e.g., six months).

In one embodiment, the advertisement selector (133) is operated by an entity that is separate from the entity that operates the transaction handler (103). For example, the advertisement selector (133) may be operated by a search engine, a publisher, an advertiser, an ad network, or an online merchant. The user specific profile (131) is provided to the advertisement selector (133) to assist the customization of the user specific advertisement data (119).

In one embodiment, advertising is targeted based on shopping patterns in a merchant category (e.g., as represented by a Merchant Category Code (MCC)) that has high correlation of spending propensity with other merchant categories (e.g., other MCCs). For example, in the context of a first MCC for a targeted audience, a profile identifying second MCCs that have high correlation of spending propensity with the first MCC can be used to select advertisements for the targeted audience.

In one embodiment, the aggregated spending profile (341) is used to provide intelligence information about the spending patterns, preferences, and/or trends of the user (101). For example, a predictive model can be established based on the aggregated spending profile (341) to estimate the needs of the user (101). For example, the factor values (344) and/or the cluster ID (343) in the aggregated spending profile (341) can be used to determine the spending preferences of the user (101). For example, the channel distribution (345) in the aggregated spending profile (341) can be used to provide a customized offer targeted for a particular channel, based on the spending patterns of the user (101).

In one embodiment, mobile advertisements, such as offers and coupons, are generated and disseminated based on aspects of prior purchases, such as timing, location, and nature of the purchases, etc. In one embodiment, the size of the benefit of the offer or coupon is based on purchase volume or spending amount of the prior purchase and/or the subsequent purchase that may qualify for the redemption of the offer. Further details and examples of one embodiment are provided in U.S. Pat. App. Pub. No. 2008/0201226, entitled “Mobile Coupon Method and Portable Consumer Device for Utilizing Same,” the disclosure of which is hereby incorporated herein by reference.

In one embodiment, conditional rewards are provided to the user (101); and the transaction handler (103) monitors the transactions of the user (101) to identify redeemable rewards that have satisfied the respective conditions. In one embodiment, the conditional rewards are selected based on transaction data (109). Further details and examples of one embodiment are provided in U.S. Pat. App. Pub. No. 2008/0082418, entitled “Consumer Specific Conditional Rewards,” the disclosure of which is hereby incorporated herein by reference. The techniques to detect the satisfied conditions of conditional rewards can also be used to detect the transactions that satisfy the conditions specified to locate the transactions that result from online activities, such as online advertisements, searches, etc., to correlate the transactions with the respective online activities.

Further details about targeted offer delivery in one embodiment are provided in U.S. Pat. App. Pub. No. 2010/0030644, entitled “Targeted Advertising by Payment Processor History of Cashless Acquired Merchant Transaction on Issued Consumer Account,” and in U.S. Pat. App. Pub. No. 2011/0035280, entitled “Systems and Methods for Targeted Advertisement Delivery,” the disclosures of which applications are hereby incorporated herein by reference.

### Profile Matching

In FIG. 1, the user tracker (113) obtains and generates context information about the user (101) at the point of interaction (107), including user data (125) that characterizes and/or identifies the user (101). The profile selector (129) selects a user specific profile (131) from the set of transaction profiles (127) generated by the profile generator (121), based on matching the characteristics of the transaction profiles (127) and the characteristics of the user data (125). For example, the user data (125) indicates a set of characteristics of the user (101); and the profile selector (129) selects the user specific profile (131) that is for a particular user or a group of users and that best matches the set of characteristics specified by the user data (125).

In one embodiment, the profile selector (129) receives the transaction profiles (127) in a batch mode. The profile selector (129) selects the user specific profile (131) from the batch of transaction profiles (127) based on the user data (125). Alternatively, the profile generator (121) generates the transaction profiles (127) in real time; and the profile selector (129) uses the user data (125) to query the profile generator (121) to generate the user specific profile (131) in real time, or just in time. The profile generator (121) generates the user specific profile (131) that best matches the user data (125).

In one embodiment, the user tracker (113) identifies the user (101) based on the user activity on the transaction terminal (105) (e.g., having visited a set of websites, currently visiting a type of web pages, search behavior, etc.).

In one embodiment, the user data (125) includes an identifier of the user (101), such as a global unique identifier (GUID), a personal account number (PAN) (e.g., credit card number, debit card number, or other card account number), or other identifiers that uniquely and persistently identify the user (101) within a set of identifiers of the same type. Alternatively, the user data (125) may include other identifiers, such as an Internet Protocol (IP) address of the user (101), a name or user name of the user (101), or a browser cookie ID, which identify the user (101) in a local, temporary, transient and/or anonymous manner. Some of these identifiers of the user (101) may be provided by publishers, advertisers, ad networks, search engines, merchants, or the user tracker (113). In one embodiment, such identifiers are correlated to the user (101) based on the overlapping or proximity of the time period of their usage to establish an identification reference table.

In one embodiment, the identification reference table is used to identify the account information (142) (e.g., account number (302)) based on characteristics of the user (101) captured in the user data (125), such as browser cookie ID, IP addresses, and/or timestamps on the usage of the IP addresses. In one embodiment, the identification reference table is maintained by the operator of the transaction handler (103). Alternatively, the identification reference table is maintained by an entity other than the operator of the transaction handler (103).

In one embodiment, the user tracker (113) determines certain characteristics of the user (101) to describe a type or group of users of which the user (101) is a member. The transaction profile of the group is used as the user specific profile (131). Examples of such characteristics include geographical location or neighborhood, types of online activities, specific online activities, or merchant propensity. In one embodiment, the groups are defined based on aggregate information (e.g., by time of day, or household), or segment (e.g., by cluster, propensity, demographics, cluster IDs, and/or factor values). In one embodiment, the groups are defined in part via one or more social networks. For example, a group may be defined based on social distances to one or more users on a social network website, interactions between users on a social network website, and/or common data in social network profiles of the users in the social network website.

In one embodiment, the user data (125) may match different profiles at a different granularity or resolution (e.g., account, user, family, company, neighborhood, etc.), with different degrees of certainty. The profile selector (129) and/or the profile generator (121) may determine or select the user specific profile (131) with the finest granularity or resolution with acceptable certainty. Thus, the user specific profile (131) is most specific or closely related to the user (101).

In one embodiment, the advertisement selector (133) uses further data in prioritizing, selecting, generating, customizing and adjusting the user specific advertisement data (119). For example, the advertisement selector (133) may use search data in combination with the user specific profile (131) to provide benefits or offers to a user (101) at the point of interaction (107). For example, the user specific profile (131) can be used to personalize the advertisement, such as adjusting the placement of the advertisement relative to other advertisements, adjusting the appearance of the advertisement, etc.

### Browser Cookie

In one embodiment, the user data (125) uses browser cookie information to identify the user (101). The browser cookie information is matched to account information (142) or the account number (302) to identify the user specific profile (131), such as aggregated spending profile (341) to present effective, timely, and relevant marketing information to the user (101), via the preferred communication channel (e.g., mobile communications, web, mail, email, POS, etc.) within a window of time that could influence the spending behavior of the user (101). Based on the transaction data (109), the user specific profile (131) can improve audience targeting for online advertising. Thus, customers will get better advertisements and offers presented to them; and the advertisers will achieve better return-on-investment for their advertisement campaigns.

In one embodiment, the browser cookie that identifies the user (101) in online activities, such as web browsing, online searching, and using social networking applications, can be matched to an identifier of the user (101) in account data (111), such as the account number (302) of a financial payment card of the user (101) or the account information (142) of the account identification device (141) of the user (101). In one embodiment, the identifier of the user (101) can be uniquely identified via matching IP address, timestamp, cookie ID and/or other user data (125) observed by the user tracker (113).

In one embodiment, a look up table is used to map browser cookie information (e.g., IP address, timestamp, cookie ID) to the account data (111) that identifies the user (101) in the transaction handler (103). The look up table may be established via correlating overlapping or common portions of the user data (125) observed by different entities or different user trackers (113).

In one embodiment, the portal (143) is configured to identify the consumer account (146) based on the IP address identified in the user data (125) through mapping the IP address to a street address.

In one embodiment, the portal (143) uses a plurality of methods to identify consumer accounts (146) based on the user data (125). The portal (143) combines the results from the different methods to determine the most likely consumer account (146) for the user data (125).

Details about the identification of consumer account (146) based on user data (125) in one embodiment are provided in U.S. Pat. App. Pub. No. 2011/0093327, entitled “Systems and Methods to Match Identifiers,” the disclosure of which is hereby incorporated herein by reference.

### Close the Loop

In one embodiment, the correlator (117) is used to “close the loop” for the tracking of consumer behavior across an on-line activity and an “off-line” activity that results at least in part from the on-line activity. In one embodiment, online activities, such as searching, web browsing, social networking, and/or consuming online advertisements, are correlated with respective transactions to generate the correlation result (123) in FIG. 1. The respective transactions may occur offline, in “brick and mortar” retail stores, or online but in a context outside the online activities, such as a credit card purchase that is performed in a way not visible to a search company that facilitates the search activities.

The correlator (117) is configured in one embodiment to identify transactions resulting from searches or online advertisements. For example, in response to a query about the user (101) from the user tracker (113), the correlator (117) identifies an offline transaction performed by the user (101) and sends the correlation result (123) about the offline transaction to the user tracker (113), which allows the user tracker (113) to combine the information about the offline transaction and the online activities to provide significant marketing advantages.

For example, a marketing department could correlate an advertising budget to actual sales. For example, a marketer can use the correlation result (123) to study the effect of certain prioritization strategies, customization schemes, etc. on the impact on the actual sales. For example, the correlation result (123) can be used to adjust or prioritize advertisement placement on a web site, a search engine, a social networking site, an online marketplace, or the like.

In one embodiment, the profile generator (121) uses the correlation result (123) to augment the transaction profiles (127) with data indicating the rate of conversion from searches or advertisements to purchase transactions. In one embodiment, the correlation result (123) is used to generate predictive models to determine what a user (101) is likely to purchase when the user (101) is searching using certain keywords or when the user (101) is presented with an advertisement or offer. In one embodiment, the portal (143) is configured to report the correlation result (123) to a partner, such as a search engine, a publisher, or a merchant, to allow the partner to use the correlation result (123) to measure the effectiveness of advertisements and/or search result customization, to arrange rewards, etc.

In one embodiment, the correlator (117) matches the online activities and the transactions based on matching the user data (125) provided by the user tracker (113) and the records of the transactions, such as transaction data (109) or transaction records (301). In another embodiment, the correlator (117) matches the online activities and the transactions based on the redemption of offers/benefits provided in the user specific advertisement data (119).

In one embodiment, the portal (143) is configured to receive a set of conditions and an identification of the user (101), determine whether there is any transaction of the user (101) that satisfies the set of conditions, and if so, provide indications of the transactions that satisfy the conditions and/or certain details about the transactions, which allows the requester to correlate the transactions with certain user activities, such as searching, web browsing, consuming advertisements, etc.

In one embodiment, the requester may not know the account number (302) of the user (101); and the portal (143) is to map the identifier provided in the request to the account number (302) of the user (101) to provide the requested information. Examples of the identifier being provided in the request to identify the user (101) include an identification of an iFrame of a web page visited by the user (101), a browser cookie ID, an IP address and the day and time corresponding to the use of the IP address, etc.

The information provided by the portal (143) can be used in pre-purchase marketing activities, such as customizing content or offers, prioritizing content or offers, selecting content or offers, etc., based on the spending pattern of the user (101). The content that is customized, prioritized, selected, or recommended may be the search results, blog entries, items for sale, etc.

The information provided by the portal (143) can be used in post-purchase activities. For example, the information can be used to correlate an offline purchase with online activities. For example, the information can be used to determine purchases made in response to media events, such as television programs, advertisements, news announcements, etc.

Details about profile delivery, online activity to offline purchase tracking, techniques to identify the user specific profile (131) based on user data (125) (such as IP addresses), and targeted delivery of advertisement/offer/benefit in some embodiments are provided in U.S. Pat. App. Pub. No. 2011/0035278, entitled “Systems and Methods for Closing the Loop between Online Activities and Offline Purchases,” the disclosure of which application is incorporated herein by reference.

### Loyalty Program

In one embodiment, the transaction handler (103) uses the account data (111) to store information for third party loyalty programs.

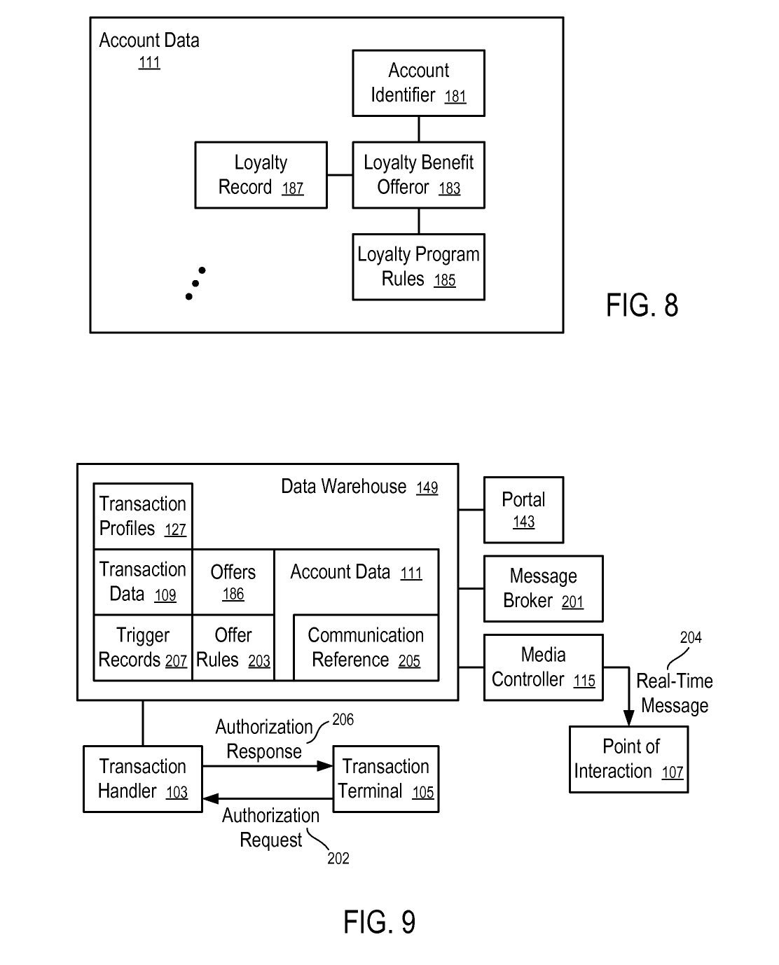

FIG. 8 shows the structure of account data (111) for providing loyalty programs according to one embodiment. In FIG. 8, data related to a third party loyalty program may include an identifier of the loyalty benefit offeror (183) that is linked to a set of loyalty program rules (185) and loyalty record (187) for the loyalty program activities of the account identifier (181). In one embodiment, at least part of the data related to the third party loyalty program is stored under the account identifier (181) of the user (101), such as the loyalty record (187).

FIG. 8 illustrates the data related to one third party loyalty program of a loyalty benefit offeror (183). In one embodiment, the account identifier (181) may be linked to multiple loyalty benefit offerors (e.g., 183), corresponding to different third party loyalty programs. The third party loyalty program of the loyalty benefit offeror (183) provides the user (101), identified by the account identifier (181), with benefits, such as discounts, rewards, incentives, cash back, gifts, coupons, and/or privileges.

In one embodiment, the association between the account identifier (181) and the loyalty benefit offeror (183) in the account data (111) indicates that the user (101) having the account identifier (181) is a member of the loyalty program. Thus, the user (101) may use the account identifier (181) to access privileges afforded to the members of the loyalty programs, such as rights to access a member only area, facility, store, product or service, discounts extended only to members, or opportunities to participate in certain events, buy certain items, or receive certain services reserved for members.

In one embodiment, it is not necessary to make a purchase to use the privileges. The user (101) may enjoy the privileges based on the status of being a member of the loyalty program. The user (101) may use the account identifier (181) to show the status of being a member of the loyalty program.

For example, the user (101) may provide the account identifier (181) (e.g., the account number of a credit card) to the transaction terminal (105) to initiate an authorization process for a special transaction which is designed to check the member status of the user (101), as if the account identifier (181) were used to initiate an authorization process for a payment transaction. The special transaction is designed to verify the member status of the user (101) via checking whether the account data (111) is associated with the loyalty benefit offeror (183). If the account identifier (181) is associated with the corresponding loyalty benefit offeror (183), the transaction handler (103) provides an approval indication in the authorization process to indicate that the user (101) is a member of the loyalty program. The approval indication can be used as a form of identification to allow the user (101) to access member privileges, such as access to services, products, opportunities, facilities, discounts, permissions, which are reserved for members.

In one embodiment, when the account identifier (181) is used to identify the user (101) as a member to access member privileges, the transaction handler (103) stores information about the access of the corresponding member privilege in loyalty record (187). The profile generator (121) may use the information accumulated in the loyalty record (187) to enhance transaction profiles (127) and provide the user (101) with personalized/targeted advertisements, with or without further offers of benefit (e.g., discounts, incentives, rebates, cash back, rewards, etc.).

In one embodiment, the association of the account identifier (181) and the loyalty benefit offeror (183) also allows the loyalty benefit offeror (183) to access at least a portion of the account data (111) relevant to the loyalty program, such as the loyalty record (187) and certain information about the user (101), such as name, address, and other demographic data.

In one embodiment, the loyalty program allows the user (101) to accumulate benefits according to loyalty program rules (185), such as reward points, cash back, levels of discounts, etc. For example, the user (101) may accumulate reward points for transactions that satisfy the loyalty program rules (185); and the user (101) may use the reward points to redeem cash, gift, discounts, etc. In one embodiment, the loyalty record (187) stores the accumulated benefits; and the transaction handler (103) updates the loyalty record (187) associated with the loyalty benefit offeror (183) and the account identifier (181), when events that satisfy the loyalty program rules occur.

In one embodiment, the accumulated benefits as indicated in the loyalty record (187) can be redeemed when the account identifier (181) is used to perform a payment transaction, when the payment transaction satisfies the loyalty program rules. For example, the user (101) may redeem a number of points to offset or reduce an amount of the purchase price.

In one embodiment, when the user (101) uses the account identifier (181) to make purchases as a member, the merchant may further provide information about the purchases; and the transaction handler (103) can store the information about the purchases as part of the loyalty record (187). The information about the purchases may identify specific items or services purchased by the member. For example, the merchant may provide the transaction handler (103) with purchase details at stock-keeping unit (SKU) level, which are then stored as part of the loyalty record (187). The loyalty benefit offeror (183) may use the purchase details to study the purchase behavior of the user (101); and the profile generator (121) may use the SKU level purchase details to enhance the transaction profiles (127).

In one embodiment, the SKU level purchase details are requested from the merchants or retailers via authorization responses, when the account (146) of the user (101) is enrolled in a loyalty program that allows the transaction handler (103) (and/or the issuer processor (145)) to collect the purchase details.

A method to provide loyalty programs of one embodiment includes the use of the transaction handler (103) as part of a computing apparatus. The computing apparatus processes a plurality of payment card transactions. After the computing apparatus receives a request to track transactions for a loyalty program, such as the loyalty program rules (185), the computing apparatus stores and updates loyalty program information in response to transactions occurring in the loyalty program. The computing apparatus provides to a customer (e.g., 101) an offer of a benefit when the customer satisfies a condition defined in the loyalty program, such as the loyalty program rules (185). In one embodiment, the loyalty benefit as identified in the loyalty record (187) can be redeemed in connection with a transaction in a way the benefit of an offer stored in association with the account identifier (181) is redeemed.

Examples of loyalty programs through collaboration between collaborative constituents in a payment processing system, including the transaction handler (103) in one embodiment are provided in U.S. Pat. App. Pub. No. 2008/0059302, entitled “Loyalty Program Service,” U.S. Pat. App. Pub. No. 2008/0059306, entitled “Loyalty Program Incentive Determination,” and U.S. Pat. App. Pub. No. 2008/0059307, entitled “Loyalty Program Parameter Collaboration,” the disclosures of which applications are hereby incorporated herein by reference.

Examples of processing the redemption of accumulated loyalty benefits via the transaction handler (103) in one embodiment are provided in U.S. Pat. App. Pub. No. 2008/0059303, entitled “Transaction Evaluation for Providing Rewards,” the disclosure of which is hereby incorporated herein by reference.

In one embodiment, the incentive, reward, or benefit provided in the loyalty program is based on the presence of correlated related transactions. For example, in one embodiment, an incentive is provided if a financial payment card is used in a reservation system to make a reservation and the financial payment card is subsequently used to pay for the reserved good or service. Further details and examples of one embodiment are provided in U.S. Pat. App. Pub. No. 2008/0071587, entitled “Incentive Wireless Communication Reservation,” the disclosure of which is hereby incorporated herein by reference.

In one embodiment, the transaction handler (103) provides centralized loyalty program management, reporting and membership services. In one embodiment, membership data is downloaded from the transaction handler (103) to acceptance point devices, such as the transaction terminal (105). In one embodiment, loyalty transactions are reported from the acceptance point devices to the transaction handler (103); and the data indicating the loyalty points, rewards, benefits, etc. are stored on the account identification device (141). Further details and examples of one embodiment are provided in U.S. Pat. App. Pub. No. 2004/0054581, entitled “Network Centric Loyalty System,” the disclosure of which is hereby incorporated herein by reference.

In one embodiment, the portal (143) of the transaction handler (103) is used to manage reward or loyalty programs for entities such as issuers, merchants, etc. The cardholders, such as the user (101), are rewarded with offers/benefits from merchants. The portal (143) and/or the transaction handler (103) track the transaction records for the merchants for the reward or loyalty programs. Further details and examples of one embodiment are provided in U.S. Pat. App. Pub. No. 2008/0195473, entitled “Reward Program Manager,” the disclosure of which is hereby incorporated herein by reference.

In one embodiment, a loyalty program includes multiple entities providing access to detailed transaction data, which allows the flexibility for the customization of the loyalty program. For example, issuers or merchants may sponsor the loyalty program to provide rewards; and the portal (143) and/or the transaction handler (103) stores the loyalty currency in the data warehouse (149). Further details and examples of one embodiment are provided in U.S. Pat. App. Pub. No. 2009/0030793, entitled “Multi-Vendor Multi-Loyalty Currency Program,” the disclosure of which is hereby incorporated herein by reference.

In one embodiment, an incentive program is created on the portal (143) of the transaction handler (103). The portal (143) collects offers from a plurality of merchants and stores the offers in the data warehouse (149). The offers may have associated criteria for their distributions. The portal (143) and/or the transaction handler (103) may recommend offers based on the transaction data (109). In one embodiment, the transaction handler (103) automatically applies the benefits of the offers during the processing of the transactions when the transactions satisfy the conditions associated with the offers. In one embodiment, the transaction handler (103) communicates with transaction terminals (105) to set up, customize, and/or update offers based on market focus, product categories, service categories, targeted consumer demographics, etc. Further details and examples of one embodiment are provided in U.S. Pat. App. Pub. No. 2010/0049620, entitled “Merchant Device Support of an Integrated Offer Network,” the disclosure of which is hereby incorporated herein by reference.

In one embodiment, the transaction handler (103) is configured to provide offers from merchants to the user (101) via the payment system, making accessing and redeeming the offers convenient for the user (101). The offers may be triggered by and/or tailored to a previous transaction, and may be valid only for a limited period of time starting from the date of the previous transaction. If the transaction handler (103) determines that a subsequent transaction processed by the transaction handler (103) meets the conditions for the redemption of an offer, the transaction handler (103) may credit the consumer account (146) for the redemption of the offer and/or provide a notification message to the user (101). Further details and examples of one embodiment are provided in U.S. Pat. App. Pub. No. 2010/0114686, entitled “Real-Time Statement Credits and Notifications,” the disclosure of which is hereby incorporated herein by reference.

Details on loyalty programs in one embodiment are provided in U.S. Pat. App. Pub. No. 2011/0087530, entitled “Systems and Methods to Provide Loyalty Programs,” the disclosure of which is hereby incorporated herein by reference.

### SKU

In one embodiment, merchants generate stock-keeping unit (SKU) or other specific information that identifies the particular goods and services purchased by the user (101) or customer. The SKU information may be provided to the operator of the transaction handler (103) that processed the purchases. The operator of the transaction handler (103) may store the SKU information as part of transaction data (109), and reflect the SKU information for a particular transaction in a transaction profile (127 or 131) associated with the person involved in the transaction.

When a user (101) shops at a traditional retail store or browses a website of an online merchant, an SKU-level profile associated specifically with the user (101) may be provided to select an advertisement appropriately targeted to the user (101) (e.g., via mobile phones, POS terminals, web browsers, etc.). The SKU-level profile for the user (101) may include an identification of the goods and services historically purchased by the user (101). In addition, the SKU-level profile for the user (101) may identify goods and services that the user (101) may purchase in the future. The identification may be based on historical purchases reflected in SKU-level profiles of other individuals or groups that are determined to be similar to the user (101). Accordingly, the return on investment for advertisers and merchants can be greatly improved.

In one embodiment, the user specific profile (131) is an aggregated spending profile (341) that is generated using the SKU-level information. For example, in one embodiment, the factor values (344) correspond to factor definitions (331) that are generated based on aggregating spending in different categories of products and/or services. A typical merchant offers products and/or services in many different categories.

In one embodiment, the SKU level purchase details are requested from the merchants or retailers via authorization responses, when the account (146) of the user (101) is enrolled in a program that allows the transaction handler (103) (and/or the issuer processor (145)) to collect the purchase details. Based on the SKU information and perhaps other transaction data, the profile generator (121) may create an SKU-level transaction profile for the user (101). In one embodiment, based on the SKU information associated with the transactions for each person entering into transactions with the operator of the transaction handler (103), the profile generator (121) may create an SKU-level transaction profile for each person.

Details on SKU-level profile in one embodiment are provided in U.S. Pat. App. Pub. No. 2011/0093335, entitled “Systems and Methods for Advertising Services Based on an SKU-Level Profile,” the disclosure of which is hereby incorporated herein by reference.

### Real-Time Messages

In one embodiment, the transaction handler (103) is configured to cooperate with the media controller (115) to facilitate real-time interaction with the user (101) when the payment of the user (101) is being processed by the transaction handler (103). The real-time interaction provides the opportunity to impact the user experience during the purchase (e.g., at the time of card swipe), through delivering messages in real-time to a point of interaction (107), such as a mobile phone, a personal digital assistant, a portable computer, etc. The real-time message can be delivered via short message service (SMS), email, instant messaging, or other communications protocols.

In one embodiment, the real-time message is provided without requiring modifications to existing systems used by the merchants and/or issuers.

FIG. 9 shows a system to provide real-time messages according to one embodiment. In FIG. 9, the transaction handler (103) (or a separate computing system coupled with the transaction handler (103)) is to detect the occurrence of certain transactions of interest during the processing of the authorization requests received from the transaction terminal (105); a message broker (201) is to identify a relevant message for the user (101) associated with the corresponding authorization request; and the media controller (115) is to provide the message to the user (101) at the point of interaction (107) via a communication channel separate from the channel used by the transaction handler (103) to respond to the corresponding authorization request submitted from the transaction terminal (105).

In one embodiment, the media controller (115) is to provide the message to the point of interaction (107) in parallel with the transaction handler (103) providing the response to the authorization request.

In one embodiment, the point of interaction (107) receives the message from the media controller (115) in real-time with the transaction handler (103) processing the authorization request. In one embodiment, the message is to arrive at the point of interaction (107) in the context of the response provided from the transaction handler (103) to the transaction terminal (105). For example, the message is to arrive at the point of interaction (107) substantially at the same time as the response to the authorization request arrives at the transaction terminal, or with a delay not long enough to cause the user (101) to have the impression that the message is in response to an action other that the payment transaction. For example, the message is to arrive at the point of interaction (107) prior to the user (101) completing the transaction and leaving the transaction terminal (105), or prior to the user (101) leaving the retail location of the merchant operating the transaction terminal (105).

In FIG. 9, the system includes a portal (143) to provide services to merchants and/or the user (101).

For example, in one embodiment, the portal (143) allows the user (101) to register the communication reference (205) in association with the account data (111), such as the account information (142) of the consumer account (146); and the media controller (115) is to use the communication reference (205) to deliver the message to the point of interaction (107). Examples of the communication reference (205) include a mobile phone number, an email address, a user identifier of an instant messaging system, an IP address, etc.

In one embodiment, the portal (143) allows merchants and/or other parties to define rules (203) to provide offers (186) as real-time responses to authorization requests; and based on the offer rules (203), the message broker (201) is to generate, or instruct the media controller to generate, the real-time message to provide the offers (186) to the user (101). For example, the offer (186) may include a discount, an incentive, a reward, a rebate, a gift, or other benefit, which can be redeemed upon the satisfaction of certain conditions required by the offer rules (203). In one embodiment, based on the offer rules (203) the message broker (201) configures a message by selecting the appropriate message template from (an) existing message(s) template(s), and inserts any relevant data (e.g., the communication reference (205)) into the selected template, then passes the configured message to the media controller (115), which delivers the message to the point of interaction (107). In one embodiment, the message broker (201) (or a subsystem) is used to manage message templates along with the rules for selecting the appropriate message template from among several potential choices.

In one embodiment, the offer rules (203) include offer details, targeting rules, advertisement campaign details, profile mapping, creative mapping, qualification rules, award/notify/fulfillment rules, approvals, etc. Creative elements for offers include text, images, channels, approvals, etc.

In one embodiment, when the offer rules (203) are activated by the merchant or advertiser via the portal (143), the message broker (201) is to generate trigger records (207) for the transaction handler (103). The transaction handler (103) is to monitor the incoming authorization requests to identify requests that satisfy the conditions specified in the trigger records (207) during the process of the authorization requests, and to provide the information about the identified requests to the message broker (201) for the transmission of an appropriate real-time message in accordance with the offer rules (203).

In one embodiment, the generation of the trigger records (207) for the transaction handler (103) is in real-time with the merchant or advertiser activating the offer rules (203). Thus, the offer rules (203) can be activated and used for the detection of the new authorization requests in real-time, while the transaction handler (103) continues to process the incoming authorization requests.

In one embodiment, the portal (143) provides information about the spending behaviors reflected in the transaction data (109) to assist the merchants or advertisers to target offers or advertisements. For example, in one embodiment, the portal (143) allows merchants to target the offers (186) based on transaction profiles (127). For example, the offer rules (203) are partially based on the values in a transaction profile (127), such as an aggregated spending profile (341). In one embodiment, the offer rules (203) are partially based on the information about the last purchase of the user (101) from the merchant operating the transaction terminal (105) (or another merchant), and/or the information about the location of the user (101), such as the location determined based on the location of the transaction terminal (105) and/or the location of the merchant operating the transaction terminal (105).

In one embodiment, the portal (143) provides transaction based statistics, such as merchant benchmarking statistics, industry/market segmentation, etc., to assist merchants and advertisers to identify customers.

Thus, the real-time messages can be used to influence customer behaviors while the customers are in the purchase mode.

In one embodiment, the benefit of the offers (186) can be redeemed via the transaction handler (103). The redemption of the offer (186) may or may not require the purchase details (e.g., SKU level purchase details). Details in one embodiment about redeeming offers (186) via the transaction handler (103) are provided in U.S. Pat. App. Pub. No. 2011/0288918, entitled “Systems and Methods for Redemption of Offers,” the disclosure of which is hereby incorporated herein by reference.

In one embodiment, when the authorization request for a purchase indicates that the purchase qualifies the offer (186) for redemption if the purchase corresponding to the authorization request is completed, the message broker (201) is to construct a message and use the media controller (115) to deliver the message in real-time with the processing of the authorization request to the point of interaction (107). The message informs the user (101) that when the purchase is completed, the transaction handler (103) and/or the issuer processor (145) is to provide the benefit of the offer (186) to the user (101) via statement credit or some other settlement value, for example points in a registered loyalty program, or credit at the point of sale using a digital coupon delivered to the purchaser via cell phone.

In one embodiment, the settlement of the payment transaction corresponding to the authorization request does not occur in real-time with the processing of the authorization request. For example, the merchant may submit the complete purchases for settlement at the end of the day, or in accordance with a predetermined schedule. The settlement may occur one or more days after the processing of the authorization request.

In one embodiment, when transactions are settled, the settled transactions are matched to the authorization requests to identify offers (186) that are redeemable in view of the settlement. When the offer (186) is confirmed to be redeemable based on a record of successful settlement, the message broker (201) is to use the media controller (115) to provide a message to the point of interaction (107) of the user (101), such as the mobile phone of the user (101). In one embodiment, the message is to inform the user (101) of the benefit to be provided as statement credits and/or to provide additional offers. In one embodiment, the message to confirm the statement credits is transmitted in real-time with the completion of the transaction settlement.

In one embodiment, the message broker (201) is to determine the identity of the merchant based on the information included in the authorization request transmitted from the transaction terminal (105) to the transaction handler (103). In one embodiment, the identity of the merchant is normalized to allow the application of the offer rules (203) that are merchant specific.

In one embodiment, the portal (143) is to provide data insight to merchants and/or advertisers. For example, the portal (143) can provide the transaction profile (127) of the user (101), audience segmentation information, etc.

In one embodiment, the portal (143) is to allow the merchants and/or advertisers to define and manage offers for their creation, fulfillment and/or delivery in messages.

In one embodiment, the portal (143) allows the merchants and/or advertisers to test, run and/or monitor the offers (186) for their creation, fulfillment and/or delivery in messages.

In one embodiment, the portal (143) is to provide reports and analytics regarding the offers (186).

In one embodiment, the portal (143) provides operation facilities, such as onboarding, contact management, certification, file management, workflow, etc. to assist the merchants and/or advertisers to complete the tasks related to the offers (186).

In one embodiment, the portal (143) allows the user (101) to opt in or opt out of the real-time message delivery service.

In one embodiment, an advertiser or merchant can select an offer fulfillment method from a list of options, such as statement credits, points, gift cards, e-certificates, third party fulfillment, etc.

In one embodiment, the merchant or advertiser is to use the “off the rack” transaction profiles (127) available in the data warehouse (149). In one embodiment, the merchant or advertiser can further edit parameters to customize the generation of the transaction profiles (127) and/or develop custom transaction profiles from scratch using the portal (143).

In one embodiment, the portal (143) provides a visualization tool to allow the user to see clusters of data based on GeoCodes, proximity, transaction volumes, spending patterns, zip codes, customers, stores, etc.

In one embodiment, the portal (143) allows the merchant or advertiser to define cells for targeting the customers in the cells based on date/time, profile attributes, map to offer/channel/creative, condition testing, etc.

In one embodiment, the portal (143) allows the merchant or advertiser to monitor the system health, such as the condition of servers, files received or sent, errors, status, etc., the throughput by date or range, by program, by campaign, or by global view, and aspects of current programs/offers/campaigns, such as offer details, package audit reports, etc. In one embodiment, reporting includes analytics and metrics, such as lift, conversion, category differentials (e.g., spending patterns, transaction volumes, peer groups), and reporting by program, campaign, cell, GeoCode, proximity, ad-hoc, auditing, etc.

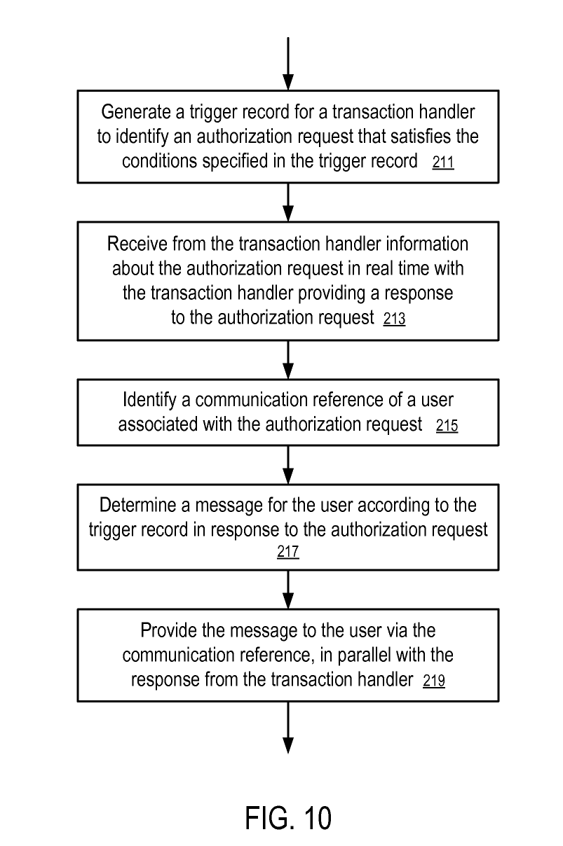

FIG. 10 shows a method to provide real-time messages according to one embodiment. In FIG. 10, a computing apparatus is configured to generate (211) a trigger record (207) for a transaction handler (103) to identify an authorization request (202) that satisfies the conditions specified in the trigger record (207), receive (213) from the transaction handler (103) information about the authorization request (202) in real-time with the transaction handler (103) providing a response (206) to the authorization request (202) to a transaction terminal (105), identify (215) a communication reference (205) of a user (101) associated with the authorization request (202), determine (217) a message (204) for the user (101) responsive to the authorization request (202), and provide (219) the message (204) to the user (101) at a point of interaction (107) via the communication reference (205), in parallel with the response (206) from the transaction handler (103) to the transaction terminal (105).

In one embodiment, the computing apparatus includes at least one of: a transaction handler (103), a message broker (201), a media controller (115), a portal (143) and a data warehouse (149).

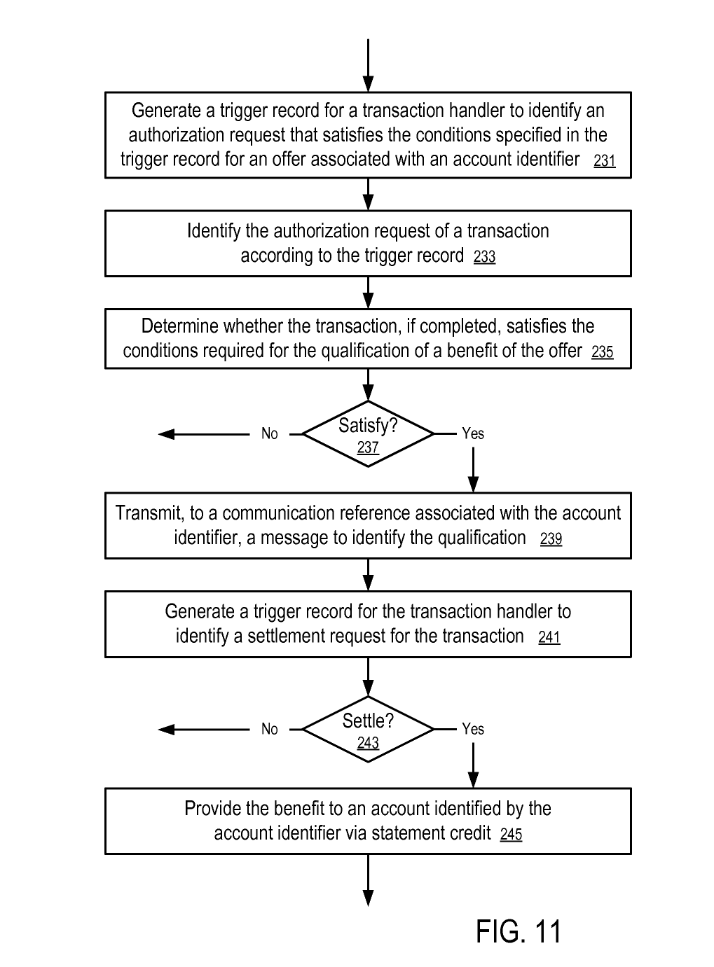

FIG. 11 shows a method to provide benefits according to one embodiment. In FIG. 11, the computing apparatus is configured to generate (231) a trigger record (207) for a transaction handler (103) to identify an authorization request (202) that satisfies the conditions specified in the trigger record (207) for an offer (186) associated with an account identifier (e.g., account data (111), account information (142), or account number (302)).

In FIG. 11, the computing apparatus is configured to identify (233) the authorization request (202) of a transaction according to the trigger record (207) and determine (235) whether the transaction, if completed, satisfies the conditions required for the qualification of a benefit of the offer (186) in accordance with the offer rules (203).

If the transaction satisfies (237) the benefit qualification conditions in accordance with the offer rules (203) of the offer (186), the computing apparatus is configured to transmit (239), to a communication reference (205) associated with the account identifier (e.g., account data (111), account information (142), or account number (302)), a message (204) to identify the qualification. The computing apparatus is configured to further generate (241) a trigger record (207) for the transaction handler (103) to identify a settlement request for the transaction. If the transaction is settled (243), the computing apparatus is configured to provide (245) the benefit of the offer (186) to a consumer account (146) identified by the account identifier (e.g., account data (111), account information (142), or account number (302)) via statement credit. In one embodiment, the statement credit is provided as part of the settlement operations of the transaction.

In one embodiment, a computer-implemented method includes: storing, in a computing apparatus having a transaction handler (103), a plurality of trigger records (207); processing, by the transaction handler (103), an authorization request (202) received from an acquirer processor (147), where the authorization request (202) is processed for a payment to be made by an issuer processor (145) on behalf of a user (101) having an account identifier (e.g., account data (111), account information (142), or account number (302)) associated with the issuer processor (145), and the acquirer processor (147) is configured to receive the payment on behalf of a merchant operating the transaction terminal (105).

In one embodiment, the method further includes: determining, by the transaction handler (103), whether the authorization request (202) matches one of the plurality of trigger records (207) by determining whether the attributes of the transaction associated with the authorization request (202) satisfies the conditions specified in one of the plurality of trigger records (207).

In one embodiment, if the authorization request (202) matches a trigger record (207) in the plurality of the trigger records (207), the computing apparatus is configured to identify a communication reference (205) of the user (101) in accordance with the trigger record (207), generate a message (204) regarding a benefit to be provided to the user (101) upon the completion of the payment, and transmit the message (204) to the user (101) via the communication reference (205) in real-time with the processing of the authorization request (202). In one embodiment, the communication reference (205) is one of: a phone number and an email address; and the message (204) is transmitted via at least one of: short message service and email.

In one embodiment, the message (204) is transmitted to a mobile phone of the user (101) via the communication reference (205).

In one embodiment, the message (204) is transmitted to the user (101) via a communication channel separate from a communication channel used to provide a response (206) to the authorization request (202).

In one embodiment, the method further includes the computing apparatus identifying an offer (186) based on transaction data (109) of the user (101); and the message (204) is configured to provide the offer (186).

In one embodiment, the computing apparatus includes the portal (143) configured to receive offer rules (203) from a merchant for the offer (186); and the offer (186) is identified for delivery in the real-time message (204) based further on the offer rules (203).

In one embodiment, the offer (186) is identified in real-time with the processing of the authorization request (202), or in response to a determination that the authorization request (202) matches the trigger record (207).

In one embodiment, the offer (186) is identified based on a profile (e.g., 131, or 341) of the user (101). In one embodiment, the profile (e.g., 131 or 341) summarizes the transaction data (109) of the user (101). In one embodiment, the computing apparatus includes the profile generator (121) configured to generate the profile (e.g., 341) from the transaction data (109) of the user (101) via a cluster analysis (329) and a factor analysis (327), as described in the section entitled “AGGREGATED SPENDING PROFILE.”

In one embodiment, the message (204) indicates that a transaction for which the authorization request (202) is processed is eligible for the benefit of an offer (186) associated with the account identifier (e.g., account data (111)) of the user (101), when the transaction is eventually completed and settled.

In one embodiment, the offer (186) is stored in the data warehouse (149) in association with the account identifier (e.g., account data (111)); and the trigger record (207) identifies the offer (186) to allow the message broker (201) to further check whether the transaction meets the benefit redemption conditions of the offer (186).

In one embodiment, the computer apparatus is configured to determine whether the payment, if completed, entitles the user (101) to the benefit of the offer (186), in response to a determination that the authorization request (202) matches the trigger record (207); and the message (204) is transmitted to the user (101) via the communication reference (205) in response to an indication of the approval of the authorization request (202) and after a determination is made that the payment, if completed, entitles the user (101) to the benefit of the offer (186).

In one embodiment, the transaction handler (103) is configured to identify a settled transaction corresponding to the authorization request (202) that triggers the message (204), and then provide the benefit of the offer (186) to the user (101) via statement credits, or loyalty program points, after the settled transaction is identified.

In one embodiment, the transaction handler (103) is configured to provide the benefit of the offer (186) to the user (101) via point of sale credit using digital coupons transmitted to cellular telephone of the user (101) during the processing of the payment at the transaction terminal (105).

In one embodiment, the transaction handler (103) is configured to process a settlement request for the payment and provide the benefit of the offer (186) to the user (101) via statement credit to a consumer account (146) corresponding to the account identifier (e.g., account data (111)) in response to the completion of the settlement of the payment, or as part of the settlement of the payment.

In one embodiment, the computing apparatus is configured to generate a second trigger record for the transaction handler (103) to monitor the settlement of the payment, in order to provide a benefit in response to the settlement of the payment, or as part of the settlement of the payment.

In one embodiment, the computing apparatus includes: a data warehouse (149) configured to store a plurality of trigger records (207); a transaction handler (103) coupled with the data warehouse (149) and configured to process an authorization request (202) received from an acquirer processor (147); and a message broker (201) coupled with the transaction handler (103) such that after the transaction handler (103) determines that the authorization request (202) matches a trigger record (207) in the plurality of the trigger records (207), the message broker (201) identifies a communication reference (205) of the user (101) in accordance with the trigger record (207) and generates a message (204) regarding a benefit to be provided to the user (101) upon completion of the payment. The computing apparatus further includes a media controller (115) coupled with the message broker (201) to transmit the message (204) to the user (101) via the communication reference (205) in real-time with the transaction handler (103) processing the authorization request (202).

Details about the system in one embodiment are provided in the sections entitled “CENTRALIZED DATA WAREHOUSE” and “HARDWARE.”

### Check-In

The action of “checking in” to a location (e.g., via a mobile phone) has turned into a social media phenomenon. More recently, “check-in” has become a powerful channel to drive foot traffic into stores by rewarding customers that check-in with exclusive messages, special discounts and virtual currency that can be redeemed for discounted purchases.

In one embodiment, check-in involves the identification of the presence of a user (101) at a physical location, such as the store of a merchant. In one embodiment, a social networking service allows the user (101) to declare the presence of the user (101) at a physical location via text messaging or via a mobile application running on a mobile phone, a smart phone, a tablet computer, etc. In one embodiment, a mobile application running on a mobile device uses the global positioning system (GPS) receiver integrated in the mobile device to determine the current location of the mobile device. The mobile application may present a list of possible physical places to which the user (101) can check-in based on the current location of the user (101); and if a location in not in the list, the user (101) may add the location to which the user (101) wants to check-in. Once the presence of the user (101) at a physical location is declared via the mobile application, the social networking service may provide the presence information of the user (101) with friends and/or relevant merchants.

Most check-in technology requires a phone application to be activated (turned on) for the check-in to work. Very often, customers that have already downloaded a specific application (e.g., Foursquare, Facebook Places, Loopt, Shopkick) forget to turn on their mobile phone and/or the mobile application, and thus merchants are not able to receive the check-in of the customer and/or verify that the customer has walked into a store, or to reward the customer for walking into the store.

Frequently, the locations determined by typical mobile phones are not accurate enough to allow precise verification of the check-in locations declared by the users (101) via the mobile phones.

In other instances, a customer may have turned on the mobile application for check-in—so the merchant knows the customer is in the store—but the merchant does not have the ability to “close the loop” or link the customer's check-in with an actual in-store purchase. Check-ins that lead to purchases would be a valuable metric for merchants to track the success of various marketing strategies and promotions. The purchase and location information would not only be valuable to the merchant from which the customer made the purchase, but would also be valuable to nearby merchants at which the customer regularly shops.

In one embodiment, a system and method is provided to combine the check-in information from a social networking system and purchase locations from a payment processing system to enhance location accuracy and/or location based services.

For example, the check-in locations are validated in one embodiment using the location information of the transaction terminal (105) to which the account identification device (141) presents the account information (142).

For example, the location information of the transaction terminal (105) to which the account identification device (141) presents the account information (142) is communicated to the social network system to automatically check-in the user (101), in accordance with the preferences of the user (101), without having to rely upon the mobile application for check-in.

For example, the check-in locations are compared to location information of the transaction terminal (105) to which the account identification device (141) presents the account information (142) to detect inaccurate or erroneous location data about the transaction terminal (105) in the payment processing system.

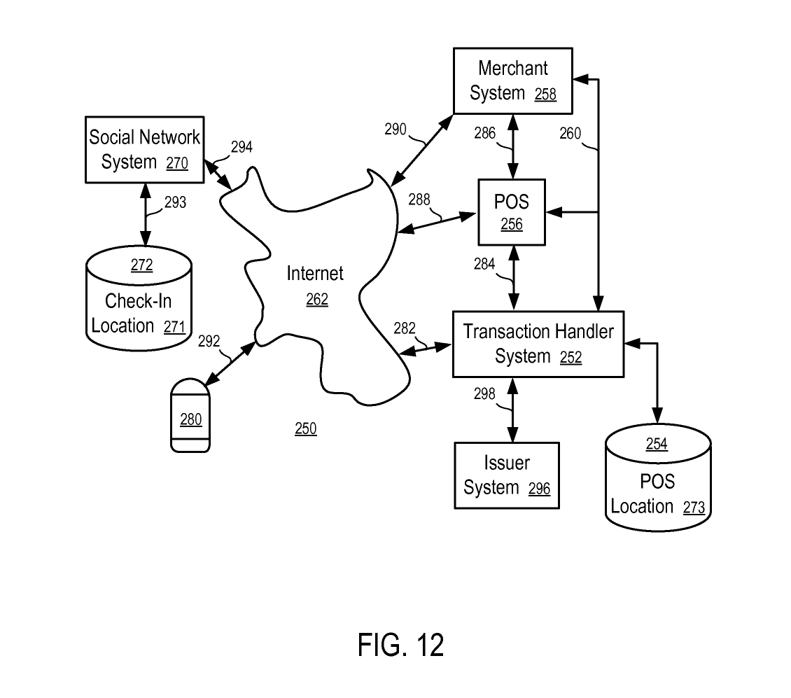

FIG. 12 illustrates an integrated system (250) for social networking check-in and payment processing according to one embodiment. In FIG. 12, the system (250) includes a transaction handler system (252), including the transaction handler (103) shown in FIGS. 1 and 4, which is in communication with a transaction handler database (254), including a data warehouse (149) as discussed above in connection with FIG. 4.

The transaction handler system (252) may be in communication (e.g., over a direct wired or wireless connection (284)) with a point of sale (POS) system (256), such as a transaction terminal (105) shown in FIGS. 1 and 4. The point of sale system (256) may be located at an establishment of a merchant, represented by a merchant account (148) (as shown in FIG. 4) having a merchant system (258), which is implemented using a computing device in one embodiment. The merchant system (258) may be in direct communication (e.g., over a direct wired or wireless connection (286)) to the point of sale system (256).

In one embodiment, connections (284) and (286), possible connections (282, 288 and 290) through a network (e.g., the Internet (262)), and connections such as through network interfaces (161) shown in FIG. 5, may be a part of the authorization network (260) for processing payment transactions via the transaction handler system (252). The transaction handler system (252) may also be connected with an issuer system (296), including an issuer processor (145) shown in FIG. 4, through a communication channel (298).

In FIG. 12, the system (250) also includes a social network system (270), which is implemented using a computing device and which is in communication with a social network database (272) through a communication connection (293) and with the Internet (262) through a connection (294). A user (101), as shown in FIG. 1, may be in communication with the Internet (262) through a point of interaction (107) shown in FIG. 1, which includes, in one embodiment, a mobile application running on a portable communication device (280) (e.g., a Blackberry, Droid, personal data assistant) for communication with the social network system (270) via a connection (292) to the Internet (262).

Social networking systems, such as Facebook, Twitter, user blog pages, etc. have been well known for some time and are in one aspect utilized in what is referred to as a check-in process. In such a check-in process, the user (101) with the portable communication device (280), for example, may declare the presence of the user (101) at a particular physical location to facilitate social interaction.

In one embodiment, the physical location may be determined automatically by the social network system (270), such as by utilization of a GPS unit associated with the portable communication device (280), or by triangulation of the signal emanating from the portable communication device (280).

In one embodiment, the user (101) may log-in to a check-in page on the social network system (270) and enter information indicating a location, followed by a location verification, such as with the GPS method, the triangulation method, or other like methods.

In one embodiment, the social network system (270) may have stored in its database (272) information about the location, such as the fact that the location is an establishment of a merchant, such as a merchant having the merchant system (258). The establishment may be entered into the social network system (270) check-in program, such as by subscribing or otherwise entering into the social network check-in service. The establishment may thus be designated as a check-in location (271) and have a check-in page on the social network system (270).

The social network system (270) may then, as an example, broadcast to all of the “friends” connected to the user (101) of the portable communication device (280), through the social network system (270), the fact that the user has checked-in at such and such a location (e.g., at the establishment of the merchant having the merchant system (258)). In such a system (250), the merchant gets advertising value because the user (101) has, in effect, endorsed the merchant's location to the social network friends of the user, (101), and the user (101) gets to notify the friends of the user (101) of the current location of the user (101).

Due to inaccuracies in the GPS or triangulation methods, etc. (e.g., when the user (101) is indoors, such as at a shopping mall or even within the establishment of the merchant), it has been estimated, in fact, that a relatively high percentage of check-ins falsely indicate the location of the user (101) at the time of the check-in. Validating the check-in locations are desirable in applications where, as part of the check-in process, the merchant or the social network, or both in cooperation, may provide the user (101) with a reward for the check-in, such as a discount on an item of merchant inventory, a free side-order if the establishment of the merchant is a restaurant, or like check-in rewards.

In addition, customers that have already downloaded a specific application (e.g., Foursquare, Facebook Places, Loopt, Shopkick) often forget to turn on their phone/application, and thus merchants are not able to verify that a customer has walked into a store, or reward that customer for walking into the store. In other instances, the customer may have turned on an application—so the merchant knows the customer is in the store—but the merchant does not have the ability to “close the loop” or link the customer's check-in with an actual in-store purchase. Check-ins that lead to purchases would be a valuable metric for merchants to track the success of various marketing strategies and promotions. The purchase and location information would not only be valuable to the merchant from which the customer made the purchase, but would also be valuable to nearby merchants at which the customer regularly shops. For the above noted reasons, auditing and/or authenticating a check-in location (271) of the user (101) is important.

In one embodiment, the system (250) of FIG. 12 is configured at least in part for check-in authentication and auditing, based on location information provided by the transaction handler system (252). After the user (101) has checked-in at a location, such as the establishment of a merchant having merchant system (258), the transaction handler system (252) can be notified of the presence of the user (101) at the establishment of the merchant having the merchant system (258). For example, in one embodiment, the transaction handler system (252) is configured to receive notification from the social network system (270) that the user (101) has declared the presence of the user (101) at a certain location associated with the establishment of the merchant having the merchant system (258). The user (101) may manually select the check-in location (271) using a web interface of the social networking system (270) or a mobile application running on the portable communication device (280) of the user; alternatively, the portable communication device (280) is configured in one embodiment to automatically identify the check-in location (271) based on a location of the portable communication device (280) (e.g., as determined by a GPS received integrated within the portable communication device (280)).

In one embodiment, an application running on the portable communication device (280) is configured to communicate the check-in location (271) of the user (101) to the transaction handler system (252) (e.g., through the Internet (262), including perhaps through the portal (143) shown in FIG. 4).

In one embodiment, the check-in location (271) identifies a merchant to indicate that the user (101) is in the establishment of the merchant. The merchant may provide offers and/or rewards, through the social network system (270), to the users (e.g., 101) who declare their check-in locations (271) at the establishment of the merchant.

In one embodiment, the user (101), as part of the registration for the social network, may be asked to provide the social network system (270) with account information (142) associated with an account identification device (141) shown in FIG. 4, such as a payment card, credit card, debit card, prepaid card, etc. In response to the declaration of the check-in location (271) of the user (101) in the social network system (270), the social network system (270) and/or the portable communication device (280) is configured to transmit a message to the transaction handler system (252) (e.g., via the portal (143) of the transaction handler (103)) to indicate the presence of the user (101) associated with the account information (142) and/or the account identification device (141) at the check-in location (271).

In one embodiment, in response to the message indicating the presence of the user (101) at the establishment of the merchant, the transaction handler system (252) is configured to monitor the payment transactions made using the account information (142) of the user (101).

In one embodiment, the transaction handler system (252) is the authorizing entity for transactions using the account information (142) and/or the account identification device (141).

Alternatively, as part of the enrollment of the user (101) in a consumer payment system (e.g., for the purpose of being issued an account identification device (141) from an issuer, or being enrolled in a program hosted on the portal (143) of the transaction handler (103)), the user (101) identifies the social network account(s) of the user (101) in the social network system (270) as being associated with the account information (142) and with a preference of the user (101) to allow the portal (143) of the transaction handler (103) to assist the user (101) in performing check-ins in the social network system (270). After the enrollment, when the user (101) performs a transaction at the point of sale system (256), the transaction handler system (252) determines the location of the point of sale system (256) from the database (254) and communicates a message to the social network system (270) to declare a check-in location (271) on behalf of the user (101), in accordance with the preference of the user (101).

In one embodiment, the data warehouse (149) of the transaction handler system (252) is configured to store data indicating the association between the social network account(s) of the user (101) and the account information (142); and the transaction handler system (252) is configured to translate the occurrence of the usage of the account information (142) at the location of the point of sale system (256) into the presence information of the user (101) at the establishment of the merchant, and thus perform check-in or verify/authenticate check-in in the social network system (270) for the respective user (101).

In this manner, the transaction handler system (252) may have stored in the transaction handler database (254), such as the warehouse (149), information from which an authorization for a purchase made using the account identification device (141) on the consumer account (146) of the user (101) can be correlated to a check-in by the user (101) at a merchant location. As one possible example, as discussed above in the section entitled “BROWSER COOKIE,” a mapping may be made of a cookie ID to a consumer purchase account number contained in the account information (142) for the user (101). In connection with the authorization process communication (260), a correlator (117), shown in FIG. 1, can correlate a transaction(s) (e.g., using the user's account identification device (141) at a point of sale system (256) within an establishment of a merchant having the merchant system (258)) with a social network check-in at the same establishment of the same merchant having the merchant system (258) (e.g., within some threshold of time before or after the occurrence of the check-in itself).

In this manner, the merchant and/or the user (101) and/or the social network may be provided with an authentication of the check-in of the user (101) at the establishment of the merchant having the merchant system (258) and the point of sale system (256) within the selected window of time on either side of the time of the transaction authenticated by the transaction handler (103). This authentication may be done through the point of sale system (256) (e.g., through a graphic user interface (not shown) on the point of sale system (256)), or through a message to the merchant system (258) and/or the point of sale system (256) (e.g., an entry into a merchant system database (not shown), a printed message on the copy of the merchant and/or the user (101) of the transaction authorization receipt).

The merchant system (258) may then issue a reward coupon to the user (101), (e.g., through the portable communication device (280) of the user (101), as part of the transaction receipt, or both). The merchant system (258) may increase the reward above a normal check-in reward when in addition to the check-in being authenticated, the user (101) has also made a purchase. An audit of check-ins by the user (101)/consumer payment account holder could combine check-in rewards with other loyalty program rewards. For example, the user (101) could receive an enhanced check-in reward (e.g., doubling the discount on a discount coupon, two free side orders) above what a user (101) would receive for a non-authenticated check-in, or receive issuer check-in rewards only for authenticated check-ins, while simultaneously receiving other loyalty program rewards associated with the purchase itself.

As an example, a loyalty program hosted on the social network system (270), the transaction handler system (252) and/or the merchant system (258) is configured to reward users (e.g., 101) for performing check-in. The check-in reward may be increased if the check-in is authenticated (e.g., via the purchase made by the user (101) at the particular establishment of the merchant having the merchant system (258) and processed by the transaction handler (103) within the specified window of time before or after the check-in).

In one embodiment, after a user (101) performs check-in via a mobile application running on the portable communication device (280) (or a web page of the social network system (270)), the social network system (270) and/or the merchant system (258) is configured to provide an offer (186) to the user (101) and communicate the offer (186) to the portal (143) to store the offer (168) with the account data (111) associated with the account information (142). Thus, the transaction handler (103) can apply the offer (186) automatically to a payment transaction, if the user (101) makes the payment transaction using the account information (142) of the consumer account (146), as discussed in the section entitled “REAL-TIME MESSAGES.”

In one embodiment, the transaction handler (252) is configured to communicate the transaction to which the offer (186) is applied to the social network system (270) and/or the merchant system (258) to close the loop from the targeting of the offer (186) to the monitoring the performance of the offer (186), in terms of purchases resulting from the offer (186). The communication identifies the purchase resulting from the check-in and/or the offer (186) that was provided to the user (101) in response to the check-in and thus validates the check-in.

In one embodiment, the transaction handler (252) is configured to report to the social network system (270) and/or the merchant system (258) the transaction that meets the requirements associated with the check-in reward to allow the social network system (270) and/or the merchant system (258) to fulfill the check-in reward.

In one embodiment, the merchant may provide a user (101) with a reward for a check-in, such as the typical discount coupon provided to the user (101); and the merchant system (258), the transaction handler system (252), the social network system (270), the issuer processor (145), or any subset of the systems acting in cooperation, may provide loyalty program rewards for the authenticated check-in, as authenticated by the transaction handler (103) obtaining an authorization for a transaction by the user (101) that checked-in on the social network system (270) using an account identification device (141) that was used in the authorization of the payment transaction initiated on the POS system (256). These check-in authentication loyalty program rewards, such as loyalty program points, may be in addition to any other loyalty program rewards arising from the purchase transaction itself.

In one embodiment, the correlator (117) is configured to correlate the user check-in information that identifies the merchant and the transaction data (109) that also identifies the merchant and/or the POS system (256) used by the merchant, based on association between the account information (142) of the user (101), the social network account of the user (101) and a time window. When the identity and/or location of the merchant as identified by the check-in information does not agree with the merchant and/or location information stored in the data warehouse (149) for the transaction terminal (105) used in the payment transaction, a potential error in the data warehouse (149) can be detected.

In one embodiment, when the mobile application running in the portable communication device (280) declares a user check-in status, the mobile application reports a check-in location (271) as determined by a location determination device of the portable communication device (280), such as a GPS receiver. The check-in location (271) may be specified as a set of coordinates of the position of the portable communication device (280) at the time the check-in status is declared, as an identification of the merchant manually selected by the user (101) via a user interface of the mobile application or automatically selected by the user (101) based on the coordinates of the position of the portable communication device (280), or as a street address determined by the mobile application based on the coordinates of the position of the portable communication device (280).

In one embodiment, the data warehouse (149) is configured to store merchant data that associates the identities of the transaction terminals (105) with the identity of the merchants and/or their physical locations, such as POS location (273). When the transaction terminals (105) are reassigned to different merchants and/or repositioned to different locations, an acquirer operating the acquirer processor (147) associated with the respective transaction terminal (105) may inform the data warehouse (149) of the change. However, the acquirer may fail to perform the task promptly or correctly, causing the data warehouse (149) to have out of date and/or erroneous information about the transaction terminal (105).

In one embodiment, the correlator (117) is configured to detect the potential error, correct the error, and/or update the merchant information in the data warehouse (149).

For example, in one embodiment, after the social network system (270) notifies the merchant and the transaction handler system (252) of the check-in of the user (101) at the establishment of the merchant system, an offer (186) provided to the user (101) as a response to the check-in of the user (101) is stored in the data warehouse (149) in association with the account data (111). When a transaction of the user (101) is determined to be eligible for the benefit of the offer (186), the transaction is associated with the check-in. Thus, the local and/or merchant information associated with the check-in can be compared with the location and/or merchant information associated with the transaction to identify inconsistency, which may be caused by the out-of-date data in the data warehouse (149), or by improper check-in declaration.

In one embodiment, when the portal (143) of the transaction handler (103) determines that a set of check-ins from different users identifies a common location and/or merchant that is different from the location and/or merchant associated with the transaction terminal (105) in the data warehouse (149), the portal (143) may flag the respective data in the data warehouse (149) for possible correction. In one embodiment, the portal (143) is configured to use the common location and/or merchant as detected from the check-in information to augment the data in the data warehouse (149).

In one embodiment, the portal (149) adjusts the data warehouse (149) to use the location and/or merchant information detected from the check-in information as a replacement of the flagged location and/or merchant information associated with the respective transaction terminal (105) for at least some applications, before a confirmation of the location and/or merchant information is received from the respective acquirer associated with the respective transaction terminal (105).

In one embodiment, the portal (143) is configured to record an indicator of the likelihood that the location and/or merchant information detected from the check-in information is more accurate than the existing location and/or merchant information associated with the transaction terminal (105). The likelihood increases as the count of check-ins that indicate the same common location and/or merchant increases. When the likelihood is above a threshold, the portal (149) is configured to generate a message to request the respective acquirer to investigate the accuracy of the location/merchant data associated with the respective transaction terminal (105).

In one embodiment, after a discrepancy in location and/or merchant information between the check-in information and the data stored for the transaction terminals (e.g., 105) in the data warehouse (149) is discovered, the portal (143) is configured to provide an offer (186) to a user (101) that declares check-in status at a respective merchant. The offer (186) is configured to include an identifier associated with the merchant and/or location as identified with the check-in information. The user (101) is required to present the identifier in a transaction to obtain the benefit of the offer (186). When the identifier of the offer (186) is presented in the authorization request, the merchant and/or location as identified with the check-in information is correlated with the transaction terminal (105) with increased certainty.

The discrepancy in location and/or merchant information may be caused by a variation in the name of the merchant used in different contexts. The discrepancy may be caused by different ways to describe a location. The discrepancy may also be a result of changes in merchant location and/or the location of the transaction terminal (105). Detecting the discrepancy can improve the data qualify of the data warehouse (149).

In one embodiment, location coordinates of the transaction terminals (e.g., 105) and/or merchants are determined based on the check-in information. For example, after the check-ins are correlated with the transactions performed using the transaction terminal (105) in response to offers (e.g., 186) provided to users (e.g., 101) who declared the check-ins with the merchant who operates the transaction terminal (105), the portal (143) is configured to filter the check-in declarations based on the location coordinates (e.g., as determined by a GPS receiver in the portable communication device (280)) to remove outliers and compute an average of the location coordinates for the transaction terminal (105) and/or the merchant. In one embodiment, in computing the average, the location coordinates are weighted based on the time gap between the declaration and the purchase. The weight assigned for a check-in declaration is decreased when the time gap between the declaration and the purchase is increased.

In one embodiment, the social network system (270) and/or the portal (143) allow the user (101) to select a preference to allow the portal (143) to check-in the user (101) at the location of the merchant, in response to the user (101) making a purchase using the consumer account (146) at the transaction terminal (105) of the merchant. After the user (101) selects the preference, the portal (143) of the transaction handler (103) is configured to monitor the transactions in the consumer account (146). In response to an authorization request or to a transaction that is associated with the consumer account (146), the portal (143) generates the message to the social network system (270) to declare the check-in of the user (101) at the respective merchant with whom the transaction is made. Thus, the user (101) can obtain the benefit of an automated check-in declaration, even if the portable communication device (280) is not currently at the establishment of the merchant, or is not turned on.

In one embodiment, prior to the portal (143) checking-in the user (101) based on the transaction, the portal (143) and/or the media controller (115) is configured to transmit a message to the user (101) to remind the user (101) about the check-in.

For example, in one embodiment, if the portal (143) determines, at the time of the processing of the transaction between the user (101) and the merchant, that the user (101) is not currently checked-in with the merchant, the message broker (201) is configured to generate a reminder for delivery via the media controller (115) to remind the user (101) of the opportunity to check-in. The user (101) may send a response to the reminder, which causes the portal (143) to check-in the user (101) with the merchant in the social network system (270). The user (101) may also use the mobile application to perform check-in.

In one embodiment, the transaction handler system (252) and/or the issuer system (296) may charge the merchant or the social network, or both, a fee for authenticating a check-in by the user (101) on the social network system (270). The transaction handler system (252) and/or the issuer system (296) may provide the social network system (270), the merchant system (258) and/or the portable communication device (280) of the user (101) with an audit of authenticated check-ins.

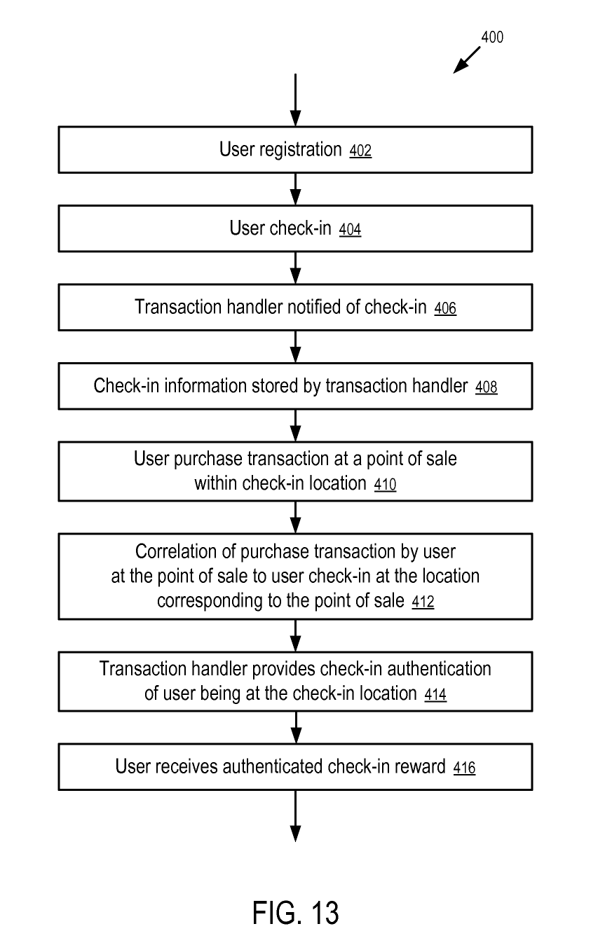

FIG. 13 illustrates a check-in authentication and auditing method (400) in block diagram form. The method includes a user registration operation (402), in which the user (101) having an application running on a compatible portable communication device (280) as shown in FIG. 12 provides the registration information that allows the correlation of the social network activities of the user (101) in the social network system (270) with the transaction activities of the user (101) in the transaction handler system (252). For example, the use of a consumer account identification device (141) associated with a consumer payment account (146) of the user (101) in the transaction handler system (252) can be correlated to a check-in in the social network system (270).

In one embodiment, in connection with subscribing to the social network, the user (101) may be required or asked to opt in to provide consumer purchase device account information, such as account information (142) shown in FIG. 4, connected to an account identification device (141), also shown in FIG. 4, which enables the social network system (270) to notify the transaction handler system (252) when the user (101) has checked-in to a location that corresponds to a merchant location.

Alternatively, as part of obtaining a consumer purchase account identification device (141) and a purchase account with an issuer or transaction processor, the user (101) may be required, or asked, to provide registration information identifying the social network account of the user (101). The transaction handler (103) may use the registration information to obtain from the social network system (270) an indication that the user (101) has checked-in to a merchant establishment location, or to inform the social network system (270) about a transaction that may be the basis for check-in of the user (101) with the merchant.

The transaction handler (103), with the permission of the user (101) being required in one embodiment, may obtain registration information directly from the social network system (270). Alternatively, the social network system (270), the transaction handler system (252), or both, may supply the user (101) with an application(s) to run on the portable communication device (280) of the user (101) that permits the portable communication device (280) to notify the transaction handler system (252) directly each time the user (101) checks-in at a check-in location (271), and provides the identity of the user (101) and the check-in location (271).

In operation (404), the user (101) (e.g., using the portable communication device (280) of the user (101)) may check-in at an establishment of a merchant having the merchant system (258), shown in FIG. 12, and the point of sale system (256), also shown in FIG. 12. In operation (406), the transaction handler system (252) is notified of the check-in by the user (101). In operation (408), the transaction handler system (252) may store the check-in information in the data warehouse (149), to associate the check-in location (271) (merchant establishment) with a consumer purchase account identification device (141), and thus with the consumer account (146), shown in FIG. 4, of the user (101). In operation (410), the user (101) may utilize the consumer purchase account identification device (141) of the user (101) at a point of sale system (256) located in the establishment of the merchant having the merchant system (258), and the transaction handler system (252) can process the authorization of the purchase transaction.

In operation (412), the correlator (117) uses data in the transaction handler database (254), such as the data warehouse (149) discussed above, to correlate the consumer account (146) of the user (101) with a point of sale system (256) that is located within the establishment of the merchant to which the user (101) has checked-in on the social network system (270). It will be understood that the sequence of checking-in and entering into a purchase transaction at the location to which the user (101) is checked-in can occur in the opposite order as well, provided the purchase is within a selected threshold of time before the check-in. In operation (414), the transaction handler system (252) can provide a check-in authentication to the point of sale system (256), the merchant system (258), the social network system (270) and the issuer system (296), or a sub-set of this group.

In operation (416), the merchant system (258), the social network system (270), the transaction handler system (252) or the issuer system (296), or one or more sub-sets of this group cooperatively as to each such sub-set, may issue an authenticated check-in reward. The authenticated check-in reward, as noted above, may be an enhanced reward along the same lines as a normal check-in reward (e.g., a bigger discount coupon, a more expensive free portion of a meal) than is usually given for a non-authenticated check-in, or may be an entirely different type of reward, such as loyalty program points or the like.

It will be understood that, in one embodiment, when customers/users (101) shop with their consumer purchase account identification device (141) (e.g., a Visa® card) inside a store, the consumer purchase account identification device (141) authentication process by a transaction handler (103) (e.g., Visa) identifies the location of the customer/user (101) instantaneously. Knowledge of a customer's presence inside a store is very valuable to the merchant, as well as the knowledge that a purchase was made. Any merchant with a loyalty/rewards program tied to a mobile application would be interested in adding this information to their database, especially if a purchase was recorded without a customer needing to turn on their phone/application in order to check-in. As a result of this location-based technology, the transaction handler (103) can integrate its location information with merchant data in instances in which customers have opted in to programs that involve messaging. The transaction handler (103) can deploy offers/messages (e.g., via SMS, email) through the real-time messaging (RTM) platform, and thus extend the communication and engagement with customers/users (101) during a critical sales window that is typically a blind spot for merchants.

In one embodiment, consumers would preferably be enrolled in an RTM program with a transaction handler or issuer of a consumer purchase account identification device (141); otherwise the merchant should secure opt-in permission to analyze the consumer's purchase data. The RTM functionality can be configured to communicate with the mobile application and transfer data to the merchant in near real-time. Alternative process operations for a check-in authentication process in other embodiments are listed below.

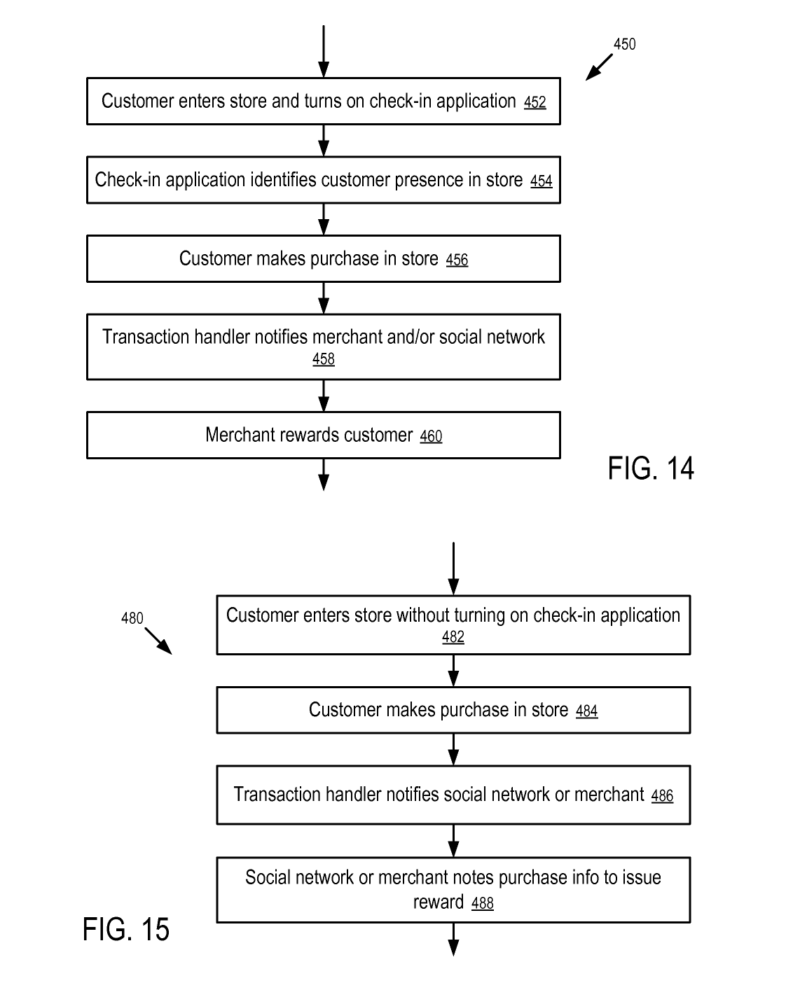

FIG. 14 illustrates a process (450) in block diagram format, in which a customer/user (101) enters (452) a store and turns on a mobile application, such as a Facebook check-in on a merchant check-in page associated with the merchant. The mobile application identifies (454) the presence of the customer/user (101) in the merchant location, and the customer/user (101) is rewarded with points, etc. (e.g., by the merchant). If the customer/user (101) makes (456) a purchase, the transaction handler (103) notifies (458) the check-in application, such as Facebook, and/or the merchant company, essentially in real-time. The merchant then rewards (460) the customer/user (101) for the check-in that was authenticated and/or for the purchase itself (e.g., through the merchant's loyalty program, which may be administered by the transaction handler (103) or the issuer of the consumer purchase account identification device (141)).

FIG. 15 illustrates another process (480) in block diagram form, in which the customer/user (101) enters (482) a merchant establishment, but does not turn on the mobile application, and thus the merchant is unaware that the customer/user (101) is in the merchant location. The customer/user (101) makes (484) a purchase; and the transaction handler (103) notifies (486) the check-in application (e.g., Facebook) and the merchant company. The check-in application (e.g., Facebook) and/or the merchant company notice (488) the purchase information, which allows the merchant to reward the customer/user (101) at a later time based on the transaction.

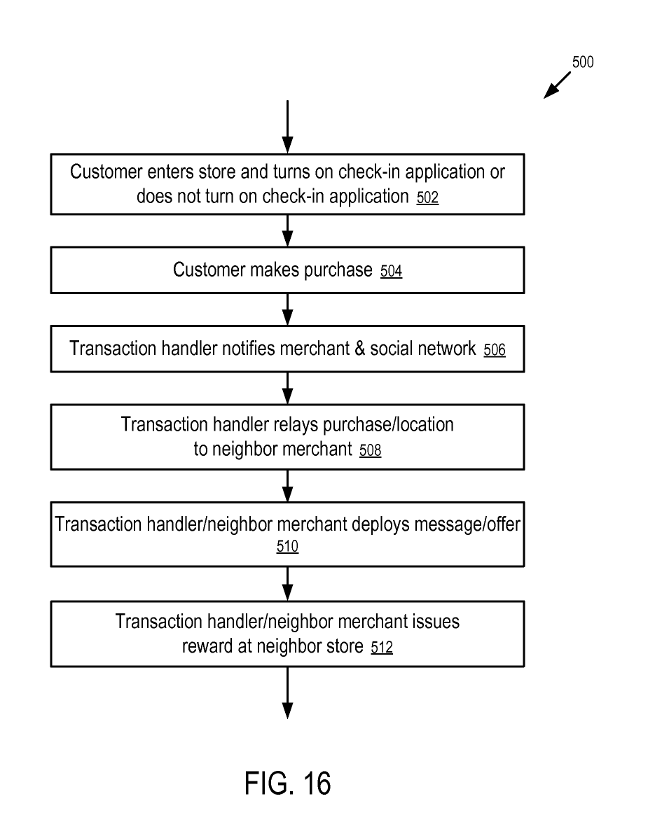

FIG. 16 illustrates another process (500) in block diagram form, in which the customer/user (101) enters (502) a store and turns on the check-in mobile application or does not turn on the check-in mobile application. The customer/user (101) makes (504) a purchase, and the transaction handler (103) notifies (506) the check-in application (e.g., Facebook) and the merchant company, and simultaneously relays (508) location and/or purchase information to neighboring merchants from which the customer/user (101) has opted in to receive communications. Neighbor merchants can deploy (510) messages/offers (e.g., via SMS, email) in real-time or near real-time to incentivize the customer/user (101) to “cross the street” and shop at their store. As an example, the customer/user (101) makes a purchase at an electronics store, and the purchase triggers an offer message from an ice cream shop across the street. The neighbor merchant (e.g., the ice cream shop) rewards (512) the customer/user (101) with points, etc. for a second purchase made at the location of the neighbor merchant.

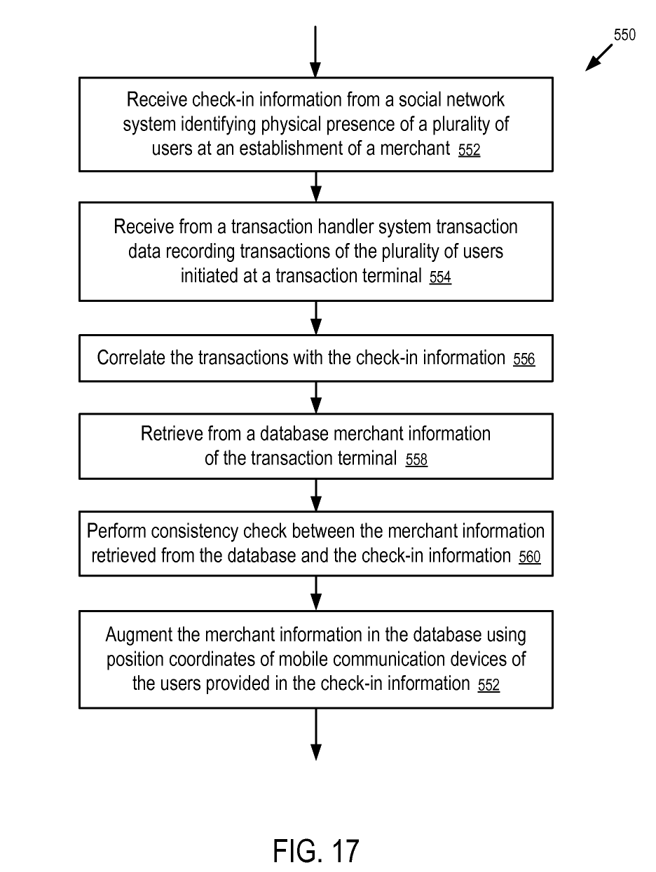

FIG. 17 shows a method (550) to combine check-in information and transaction locations according to one embodiment. In FIG. 17, a computing apparatus is configured to receive (552) check-in information from a social network system (270) identifying the physical presence of a plurality of users (e.g., 101) at an establishment of a merchant (e.g., check-in location (271)); receive (554) from a transaction handler system (252) transaction data (109) recording transactions of the plurality of users (e.g., 101) initiated at a transaction terminal (105); correlate (556) the transactions with the check-in information (e.g., check-in location (271)); retrieve (558) from a database (e.g., hosted in the data warehouse (149)) merchant information of the transaction terminal (105); perform (560) a consistency check between the merchant information retrieved from the database and the check-in information; and augment (562) the merchant information in the database using position coordinates of mobile communication devices (e.g., 280) of the users (e.g., 101) provided in the check-in information.

In one embodiment, the computing apparatus/system includes at least one of: the portal (143) to interface with the social network system (270), the message broker (201) to provide real-time messages containing offers (186) to the users (e.g., 101) concurrently or in parallel with the processing of the respective transactions that trigger the offers (186), the media controller (115) to transmit the real-time messages to communication references (205) of the users (e.g., 101), the data warehouse (149) to store the merchant information and other data, the transaction handler (103) to process the transactions for authorization and settlement, the correlator (117) to correlate the transactions and check-ins, and the merchant system (258) to provide check-in rewards.

In one embodiment, the correlator (117) is configured to correlate transactions with check-ins based on one or more parameters, such as the time gap between the check-in declaration and the transaction, the merchant identification, the merchant category identification, the offers provided in response to the check-in and redeemed in the transactions, the association between the social network account of the user (101) and the account information (142) of the user (101) used in the transaction to identify the consumer account (146) of the user (101), etc. Some techniques for correlation with the check-ins and transactions in one embodiment are provided in the section entitled “CLOSE THE LOOP.”

It will be understood that various modifications of the systems and methods described above can be made without departing from the spirit of the disclosed subject matter.

The notice to the user (101), the merchant and others of the authentication of a check-in and the concomitant issuance of a reward or reward coupon, or the like, may take many forms, and these forms may affect the redemption of the reward by the user (101). For example, the user (101) may be notified of the respective reward through the portable communication device (280) of the user (101), such as with a graphic display on the graphical user interface of the device (280), which graphic display may also be provided to the merchant system (258). The graphic display could be textual, at least in part, and can be used by the merchant through the merchant system (258) and/or the point of sale system (256) for the purpose of verifying the authenticity of the reward coupon/token (i.e., the user (101) must present the graphic display to get the check-in reward).

If combined with an issuer and/or merchant loyalty program, there are a variety of ways in which the user loyalty account can be credited with loyalty program currency of some form. There are also a variety of ways in which the user (101) can convert and use the loyalty program currency awarded for the authenticated check-in, which will be well understood by those knowledgeable of the consumer purchase account/merchant loyalty program art (e.g., a Visa® loyalty program), as described in the section “LOYALTY PROGRAM” above, and as described in one or more of the above referenced patents.

The social network system (270) can interact with the transaction handler system (252) and/or the user portable communication device (280) without the need to specifically set up a check-in location page into which a user (e.g., 101) can log-in for check-in purposes. Thus, separate pages for each possible check-in location (271) (or even each possible check-in location (271) that corresponds to a merchant establishment) need not necessarily be used. The check-in information as to location and/or corresponding merchant establishment could simply be stored in the social network database (272), where it may be indexed or otherwise organized and arranged for easy extraction from the database (272).

It will be understood by those knowledgeable in the art that a method and apparatus are disclosed according to aspects of the disclosed subject matter that may comprise receiving by a transaction handler system (252), via a communication network, a social network system (270) check-in notice identifying a user point of interaction device (e.g., 280) that has checked-in using a social network system (270) check-in functionality and a check-in location (271); correlating by the transaction handler system (252), via a computing device, the check-in notice to a transaction authorization on a consumer account of the user (101) at a point of sale system (256) within the check-in location (271), the point of sale system (256) connected to a merchant system (258) of a merchant; and notifying by the transaction handler system (252) of at least one of the user (101) and the merchant of an authenticated check-in. The user (101) may be provided with an authenticated check-in reward token, via the communication network, by one of the transaction handler system (252), the social network system (270) and the merchant system (258), by at least one of the portable communication device (280) of the user (101) and a transaction authorization receipt. The merchant may be provided with a notification on a transaction authorization receipt or by other means, such as a posting on a website of the merchant or an email message to the merchant.

In a possible alternate embodiment, the transaction handler (103) may communicate to the social network system (270) information relating to transactions occurring at locations of point of sale systems (256) on consumer accounts (146) for which the transaction handler (103) obtains authorizations, in order for the social network system (270) to authenticate the check-in. This may also be a response to a request from the social network system (270) (e.g., made by the social network system (270) through the transaction processor portal (143), shown in FIG. 4), whereby the social network (e.g., automatically through the social network system (270)) can send a query to the transaction handler system (252) (e.g., through the portal (143)) about authentication of check-ins (e.g., that have been communicated by users (101) to the social network system (270)). The query could be about check-ins which might occur, for example, for all social network participants correlating purchases to any point of sale system (256) or to any point of sale system (256) at a particular merchant location for a merchant registered with the social network, and/or with the transaction handler (103), to participate in a check-in authorization auditing program.

The social network or the transaction handler (103) may charge the merchant for such participation by the merchant and concomitant notifications. Such queries (e.g., through the portal (143)) may be limited to certain criteria, such as a specific period of time or the specific purchase of a good or service subject to a previously issued targeted advertisement directed to the particular user(s) (101). That is, the merchant may have an arrangement with the social network to be informed of social network check-ins and the social network and merchant could then both make queries through the portal (143) and receive check-in authentication information from the transaction handler (103) (e.g., related to specific check-ins that have occurred within a threshold of time in the past).

Independent of such queries by the social network or the merchant, the social network, the merchant or the transaction handler (103) could prompt the user (101) to check-in (e.g., through the portable communication device (280) of the user (101)). That is, the transaction handler (103) may remind the user (101) to check-in, as part of the authorization process or in conjunction with the authorization process and/or the merchant based on transaction information (e.g., part or all of the transaction data (109) collected by the transaction handler (103), received from the transaction handler (103), or the social network based on such transaction information). Along with the reminder to check-in, a reminder of the possible rewards and benefits for checking-in and/or a targeted offers/advertisement could be sent to the user (101). In this regard, the messaging system discussed in regard to FIG. 1 and FIG. 9 may be used to provide such an offer/advertisement, whether selected by the transaction handler (103) (e.g., an offer/advertisement from a merchant neighboring the current location of the user (101)), as discussed above in regard to those figures, or selected by the merchant or social network.

As an alternative embodiment, whether or not the system (250) provides a prompt to the user (101) to check-in at the location where a transaction resulted in transaction data (109) being collected by the transaction handler (103) and provided to the issuer processor (145) and the merchant system (258) as part of the authorization communications (260), the transaction processor may check-in the user (101) or inform the social network system (270) to check-in the user (101).

Thus, the merchant and social network get the benefit of the notification of the friends of the user (101), and the transaction handler (103) may charge the merchant or the social network, or both, for the check-in initiated by the transaction handler (103). At the same time, however, the merchant or social network may avoid any need for a check-in reward for the user (101) for a check-in not initiated by the user (101). The system (250) may be configured to give the user (101) some period of time after, for example, a prompt has been issued or a transaction authenticated, before the transaction handler (103) can execute a check-in of the user (101) and receive the benefits of such a non-user initiated check-in.

In response to the user (101) making an additional purchase (e.g., as offered/advertised in the above noted communications to the user (101) in connection with check-ins by or on behalf of the user (101)), the transaction handler (103) or the merchant, or both, could issue further rewards, such as under a loyalty program of the transaction handler (103) or issuer and/or under a merchant loyalty program, as is well known in the art and discussed in one or more of the above referenced patents. The above noted and other interactions between the check-in authentication and auditing system (250) discussed above, and such transaction handler (103)/issuer programs as offered by, e.g., Visa, such as Visa® Media Service, Visa® Real-Time Messaging, Visa® Loyalty Program, Targeted Offers, Aggregated Spending Profiler, etc., described in more detail in one or more of the above referenced patents, will be understood by those skilled in the art.

The above and other possible variations will be readily apparent to those knowledgeable in the social network, consumer purchase device, transaction processing and associated loyalty/rewards program arts.

### Travel Tag

In one embodiment, a data service is configured to provide location indicator in an authorization request for a payment transaction to reduce incorrect authorization declines when cardholders travel.

For example, a tag can be provided in the authorization request to indicate that cardholder who may be traveling is using a card at a merchant location that matches a location or destination identified on a purchased travel itinerary applicable to the current time period.

For example, after a cardholder uses a payment account to buy an airline ticket to a destination location from an airline or a travel agent, the cardholder may make a purchase using the same payment account in an area near the destination location. The location of the merchant involved in the purchase is determined or identified by the country code of the merchant, a location, position or street address stored in a database in association with the merchant account and/or the transaction terminal of the merchant. When the location of the merchant matches the travel destination, a first indicator (e.g., “A”) is added to a field in the authorization request transmitted to the issuer processor; and when destination does not match with the merchant location, a second indicator (e.g., “B”) is added to the field in the authorization request transmitted to the issuer processor. Thus, the location indicator provided in the authorization request can be used by the issuer processor to determine whether authorize the transaction or decline the transaction.

In one embodiment, no location indicator is provided in the authorization request when no travel location information is applicable to the transaction. For example, when the payment account has not been used to purchase a travel arrangement (e.g., an airline ticket, a train ticket, a cruise ticket, a hotel reservation, a rental car) that is applicable to or relevant to the present payment transaction, no indicator is added to the field in the authorization request.

To reduce fraud in which a stolen card is first used to purchase an travel itinerary and then make other purchase at the travel destinations to trick the system to think that the cardholder is traveling, mobile alert can be used in connection with the location indicator/travel tag that is provided in the authorization request to reduce incorrect authorization declines due to travel.

For example, when the travel itinerary and/or the subsequent purchases are made, a mobile alert may be sent to the cardholder to indicate that the travel tag feature may be applied. The cardholder may optionally turn travel tag off, or report the fraudulent purchase based on the mobile alert that is transmitted to the user in parallel with the processing of the authorization of the corresponding transactions.

In one embodiment, a data warehouse of a payment processor (e.g., a transaction handler of a payment processing network, an issuer processor) is configured to collect travel data and transaction locations, and generate a model or location profile for destination match. The model or location profile can be used to determine whether or not a merchant location is considered a match with a travel destination. For example, the model or location profile can be used to determine the probability or likelihood that the user travels to the merchant location to make the payment transaction in view of the travel arrangement. Correlating the historical travel proximity data extracted from transaction data warehouse can be used to optimize travel tag accuracy.

In one embodiment, the system is configured to use past transaction data and travel data to establish a location model to match a travel destination with a set of merchant locations that are likely to be visited by users traveling to the destination, provide tags in authorization requests for transactions in payment accounts of traveling users to inform payment processors about the travels of the users to reduce incorrect authorization declines, and/or provide mobile alerts related to the tags to traveling users of the payment accounts to reduce security risk. Thus, the system offers a comprehensive solution to address the problem associated with cardholder travel away from their home regions.

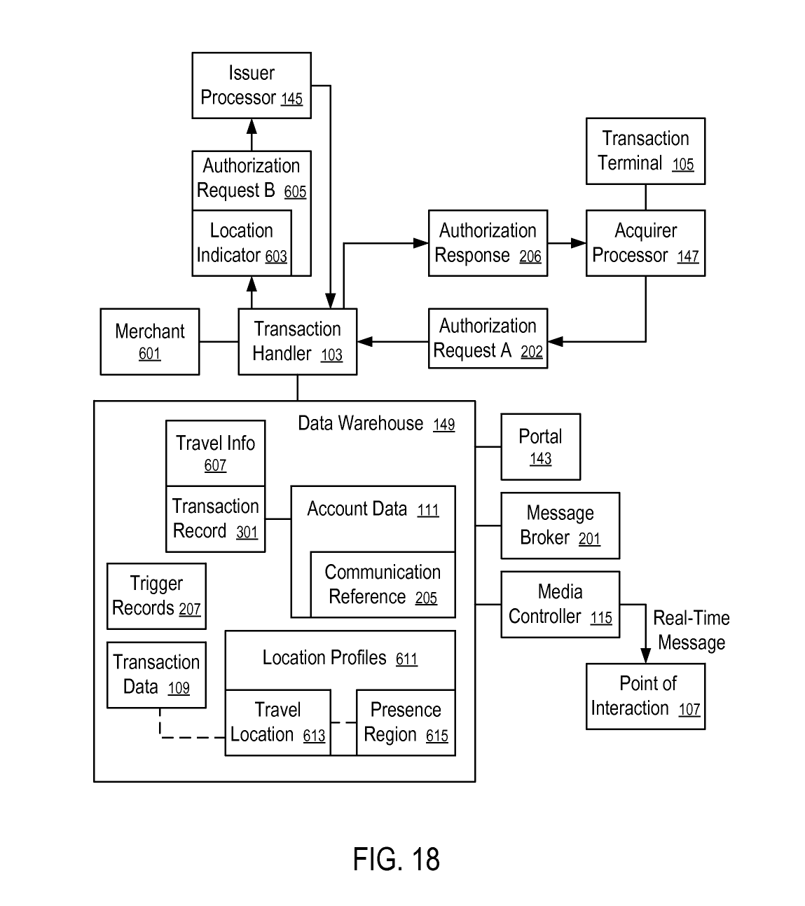

FIG. 18 shows a system to transmit location information in an authorization request according to one embodiment.

In one embodiment, the system illustrated in FIG. 18 includes a data warehouse (149) configured to store transaction data (109) recording the payment transactions made in user accounts (e.g., 146) and travel information (e.g., 607) of the respective users. Through correlating the travel time of the users as indicated in the travel information (e.g., 607) and the transaction time of the user as indicated in the transaction data (109), the travel destinations as indicated in the travel information (e.g., 607) can be associated with the transaction locations of the transaction terminals for the respective payment transactions recorded in the transaction data (109).

For example, after identifying a travel destination in the travel information (607) associated with the account data (111) of the consumer account (146) of the user (101), the date and/or time of the user (101) arriving at the destination is extracted from the travel information (607). The card-present transactions that were made in the consumer account (146) of the user (101) within a predetermined time period from the arrival at the destination (e.g., a day, two day, a week) are identified from the transaction data (109). After determining the locations of the transaction terminals that initiated the card-present transactions, the locations are associated with the travel destination and/or the predetermined time period. The process can be repeated for other travels of the user (101) and/or other users for the travel destination to identify transaction locations for the predetermined time period. The transaction locations associated with the travel destination for the predetermined time period forms a location profile for the travel destination. The process can also be repeated for different time periods to obtain different sets of transaction locations associated with the travel destination for different time periods since the arrival the destination.

The location profile of a travel destination can be used to determine whether a payment transaction initiated in a user account at a specific transaction terminal is consistent with the plan of the user to travel to the destination.

For example, the transaction locations in the location profile of the travel destination can be used to identify a geographic region that includes most or all of the transaction locations; and when the specific transaction terminal is with the geographic region, the location of the payment transaction is considered to be a match to the destination of the travel plan of the user.

For example, the location of the specific transaction terminal may be compared to the transaction locations in the location profile of the travel destination; and when the location of the specific transaction terminal matches with one of the transaction locations in the location profile of the travel destination, the location of the payment transaction is considered to be a match to the destination of the travel plan of the user.

In one embodiment, the location profile may further include a frequency indicator of the transaction locations included in the location profile. Thus, the location profile can be used to determine the likelihood of a transaction in the payment account (146) of the user (101) being consistent with the travel destination of the user (101).

For example, a geographic region can be determined to include transaction locations having frequencies above a threshold but not include transaction locations having frequencies below the threshold. When the transaction is within the geographic region, the transaction is likely to be consistent with the travel destination of the user at a level corresponding to the threshold. Different thresholds can be used to establish different geographic regions of different likelihood.

For example, when the location of a payment transaction matches with a transaction location in the location profile of the travel destination, the frequency indicator of the matched transaction location provides an indication of how likely the transaction is consistent with the travel plan of the user (101).

In FIG. 18, the data warehouse (149) is configured to store transaction data (109) and travel information (e.g., 607) of various users of consumer accounts (e.g., 146). The travel information (e.g., 607) identifies a set of travel destinations of these users during their time periods of travel. Payment transactions made in respective payment accounts of the respective users at merchant locations at or near the destination locations of the respective users are identified based on the time periods of their travel. Thus, the location profiles (611) can be derived from the correlation of the transaction data (109) and the travel destinations to indicate the likelihood of a user being present in the presence region (615) when the travel arrangement of the user (101) includes a travel location (613).

Alternatively, the location profile (611) may identify the likelihood of a user (101) visiting a particular merchant outside a home region of the user (101) while the user (101) has a travel arrangement that includes the travel location (613).

In some embodiments, the location profile (611) are constructed to be further dependent upon other parameters, such as the home regions of the users, income levels of the users, the spending/transaction profiles of the users, the mode of the travel to the destination location, etc.

For example, the likelihood or travel region (613) can be modeled to be depending on not only the destination, but also other parameters, such as the time period from the arrival at the destination, the mode of transportation to the destination, a subsequent destination, a prior destination, elapsed time from the prior destination, remaining time to the subsequent destination, parameters of the aggregated spending profile (341) of the users, etc.

In one embodiment, the travel information (e.g., 607) is based at least in part on a travel itinerary booked via the payment account (e.g., 146) of the respective user (101). The travel itinerary identifies the destinations via the airport and/or city.

In one embodiment, the travel information (607) is obtained by the transaction handler (103) as part of the transaction record (301) for the corresponding payment transaction that is used to pay the travel itinerary. Alternatively, or in combination, the portal (143) is configured to provide a user interface to allow the user to upload or register the travel information in association with a transaction record (301).

Based on transaction profiles (611) determined from the correlation of historical travel information and transaction, the presence region (615) in which the user is likely to visit merchants to make purchases using the corresponding payment account (e.g., 146) can be determined for the travel destination identified from the current travel information (607) of the user (101) that matches with presence region (615) of the travel location (613) in the transaction profile (611).

The presence region (615) can be identified, in one embodiment as a geographical region centered at the travel location (613) with a radius computed based on the purchase locations made by users who had the same or similar travel arrangements.

Alternatively, the presence region (615) can be identified as a set of merchant locations that have a likelihood of being visited by users who had the same or similar travel arrangements, in accordance with the correlation between the historical travel information and transaction data (109).

In one embodiment, the presence region (615) is identified based on a boundary encircling the set of merchant locations that have a likelihood of being visited by users who had the same or similar travel arrangements, in accordance with the correlation between the historical travel information and transaction data (109).

After the location profiles (611) are generated, the system can use the location profiles (611) to determine whether a transaction, initiated at a transaction terminal (105) using the consumer payment account (146) of the user (101) who has the current travel arrangement identified by the travel information (607), is within the current presence region (615) consistent with the travel location (613) of the user (101).

For example, after the user (101) makes a travel arrangement using the consumer payment account (146) of the user (101) with the merchant (601), the transaction handler (103) (and/or the portal (143)) is configured to receive the travel information (607) from the merchant (601).

Alternatively, or in combination, the user (101) may provide the travel information (607) to the data warehouse (149) via the portal (143) (e.g., using a mobile application, a social networking application, etc.). In some embodiments, the user (101) may further identify one or more other payment accounts for association with the travel information (607) for the service of adding travel information in authorization requests to reduce incorrect authorization declines.

Optionally, the portal (143) may be configured to use the message broker (201) and the media controller (115) to transmit a message to the point of interaction (107) using the communication reference (205); and the message is configured to confirm the travel information (607) and/or provide an option for the user (101) to opt in or opt out of the services that use the travel information (607) in assisting authorization decisions.

In one embodiment, the travel information (607) used for assisting authorization decisions is received at a time before the travel of the user (101). For example, the travel information (607) may identify an airline flight ticket purchased by the user (101), a hotel reservation made by the user (101), a rental car reservation made by the user (101), etc. An alert is generated by the message broker (201) in connection with the authorization request for the transaction associated with the purchase or reservation of the travel arrangement. In one embodiment, the alert is configured to allow the user (101) to respond and report a fraudulent purchase of the travel arrangement, and/or opt in (or opt out of) the service to add a travel tag in authorization request for the payment account of the user (101) during the travel of the user (101).

In one embodiment, in preparation of using the travel information (607) in assisting authorization decisions during the travel time period of the user (101), the portal (143) is configured to generate one or more trigger records (207) to detect transactions made in the consumer payment account (146) of the user (101) during the time period of travel of the user (101).

For example, when the trigger record (207) is active during the travel period of the user (101), the transaction handler (103) is configured to identify, among multiplicity of authorization requests processed by the transaction handler (103), the authorization request (202) from a transaction terminal (105) that is outside the home region of the user (101). The home region may be identified by the zip code (347) in an aggregated spending profile (341) of the user, a city or state of a residence address of the user, a dominant region in which most of card-present transactions of the user occurs, etc.

In response to the detection of the authorization request (202) from the acquirer processor (147) associated with the transaction terminal (105) outside the home region of the user (101), the transaction handler (103) and/or the portal (143) is configured to use the location profiles (611) to determine whether or not the location of the transaction terminal (105) is within the current presence region (615) of the travel location (613) corresponding to the current travel information (607) of the user (101). A location indicator (603) is provided in the authorization request (605) for the payment transaction in accordance with a result of the determination.

For example, the location indicator (603) can be a set to a first state (e.g., represented by a letter “A” or a value of 1) when the location of the transaction terminal (105) is in the current presence region (615) of the user (101), in view of the travel information (607) of the user (101); and the location indicator (603) can be a set to a second state (e.g., represented by a letter “B” or a value of 0) when the location of the transaction terminal (105) is not in the current presence region (615) of the user (101), in view of the travel information (607) of the user (101).

In one embodiment, the location indicator is not provided when the transaction is made in the home region of the user (101), or the user (101) chose to opt out of the service (or not opt in the service)

In one embodiment, when the authorization request (206) does not have an applicable presence region (615) corresponding to a travel plan (e.g., when the transaction is a card-not-present transaction), the location indicator (603) is not present in the authorization request (605) forwarded to the issuer processor (145) of the consumer account (146) of the user (101).

Optionally, when the location indicator (603) is set in the authorization request (605) to indicate that the transaction terminal (105) is in the current presence region (615) of traveling in accordance with the travel information (607) of the user (101), the message broker (201) is configured to transmit a real-time message via the media controller (115) to the point of interaction (107) identified by the communication reference (205) in the account data (111) of the user (101). The real-time message alerts the user (101) about the payment transaction occurring outside the home region of the user (101) and provides an option to respond and report fraudulent uses of the consumer account of the user (101) in real-time.

Thus, the arrangement of the system of FIG. 18 can reduce incorrectly declined transaction due to travel while maintaining and/or improving security against frauds and misuses.

In some embodiments, the location indicator (603) may identify the current presence region (615) and/or the probability that the location of the transaction terminal (105) is in the current traveling presence region (615).

The location profiles (611) can be used directly by the issuer processor (145) to determine whether or not the transaction terminal (105) is in the current travel/presence region (615) of the user (101). For example, the issuer processor (145) may be configured to receive the location profiles (611) from the portal (143) to determine whether the location of the transaction terminal (105) is within the current presence region (615) of the user (101) who is traveling.

Alternatively, the issuer processor (145) may derive location profiles based on historical travel and transaction data collected in the data warehouse of the issuer processor (145).

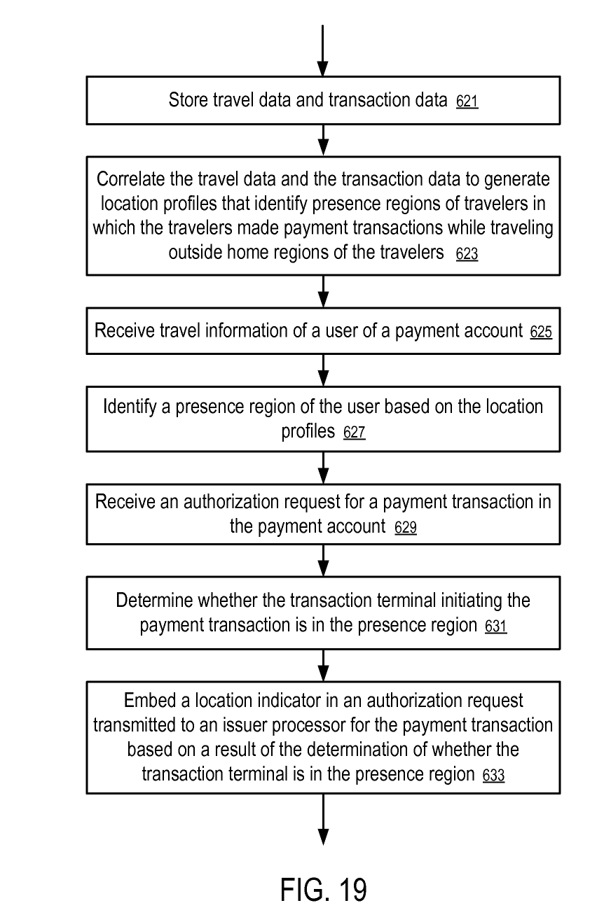

FIG. 19 shows a method to transmit location information in an authorization request according to one embodiment. For example, the method of FIG. 19 can be implemented in a system illustrated in FIG. 18.

In FIG. 19, a computing apparatus is configured to: store (621) travel data (e.g., 607) and transaction data (109); correlate (623) the travel data and the transaction data (109) to generate location profiles (611) that identify presence regions (615) of travelers in which the travelers made payment transactions while traveling outside home regions of the travelers; receive (625) travel information (607) of a user (101) of a payment account (146); identify (627) a presence region (615) of the user (101) based on the location profiles (611); receive (629) an authorization request (206) for a payment transaction in the payment account (146); determine (631) whether the transaction terminal (105) initiating the payment transaction is in the presence region (615); and embed (633) a location indicator (603) in an authorization request (605) transmitted to an issuer processor (145) for the payment transaction based on a result of the determination of whether the transaction terminal (105) is in the presence region (615).

In one embodiment, the travel information (607) is received in connection with, or as part of, a payment transaction made using the payment account (146) to book the travel plan.

In one embodiment, the payment transaction made using the payment account (146) to book the travel plan includes a payment for a purchase of an airline flight ticket to the location to be visited in the travel plan of the user (101); and the location to be visited in the travel plan of the user is a travel destination; and the method may further includes: identifying the travel region based on the travel destination specified in the travel information (607) of the user, to determine whether the location of the transaction terminal (105) is in the travel region (e.g., 615).

In one embodiment, the travel destination is specified via an identification of an airport for an airline flight ticket purchased using the payment account.

In one embodiment, the boundary of the travel region (e.g., 615) is determined via: storing travel information (e.g., 607) of a plurality of second users; identifying flights of the second users to the airport; identifying payment transactions made using payment accounts of the second users during travel time periods following the flights to the airport; determining locations of transaction terminals (e.g., 105) that initiated the payment transactions; and computing the boundary of the travel region (e.g., 607) for association with the airport based on the locations of the transaction terminals that initiated the payment transactions during the travel time periods of the second users.

In one embodiment, the boundary of the travel region (e.g., 615) associated with the travel destination (e.g., 613) is computed based on historical correlation of travel information of a plurality of second users and transaction locations of the second users during respective travels identified by the travel information of the plurality of second users.

In one embodiment, the travel information (607) of the user (101) identifies one or more travel destinations (e.g., 613) of a travel arrangement purchased using the payment account; and the travel region (e.g., 615) is identified based on a destination of the travel arrangement of the user (101), such as a ticket for travel; a lodging reservation; and a vehicle rental reservation.

In one embodiment, the boundary of the travel region (e.g., 615) is further based on a time gap between arrival at the destination and payment transaction at the transaction locations.

In one embodiment, the computing apparatus is configured to store data associating the payment account identified by the account data (111) of the user (101) with a communication reference (205) of the user (101). In response to an authorization request in a payment transaction in the payment account (146) identified by the account data (101) for the travel arrangement, the computing apparatus transmits a message to the communication reference (205) associated with the payment account (146), where the message is configured to identify the travel arrangement for confirmation and an option regarding adding the indicator in subsequent authorization requests while the user is traveling according to the travel arrangement.

In one embodiment, the computing apparatus is further configured to transmit, in parallel with transmitting to the issuer processor (145) the authorization request (605) containing the indicator (603), to the communication reference (205) a message about the payment transaction initiated at the transaction terminal in the travel region (615) that is consistent with the travel plan of the user and is outside the home region of the user (101).

In one embodiment, the computing apparatus includes a transaction handler (103) of a payment processing network having issuer processors (e.g., 145) and acquirer processors (e.g., 147), where the authorization request (202) is received by the transaction handler (103) from an acquirer processor (147) of the merchant operating the transaction terminal (105) before being forwarded as the modified authorization request (605) that includes the indicator (603).

In one embodiment, the computing apparatus is configured to: determine a travel destination of the travel plan of the user; determine a time gap between arrival of the user at the travel destination and the authorization request (202); and identify a boundary of the presence region (615) of the user (101) based on the travel destination and the time gap, such that whether or not the transaction terminal is located with the travel region of the user is based on the boundary identified from the travel destination and the time gap.

In one embodiment, the computing apparatus includes at least one of: the data warehouse (149), the portal (143), the message broker (201), the media controller (115), and the issuer processor (145), each of which can be implemented using one or more data processing systems, such as the data processing system illustrated in FIG. 7.

Details about the system in one embodiment are provided in the sections entitled “CENTRALIZED DATA WAREHOUSE” and “HARDWARE.”

### Variations

Some embodiments use more or fewer components than those illustrated in the figures.

In one embodiment, at least some of the profile generator (121), correlator (117), profile selector (129), and advertisement selector (133) are controlled by the entity that operates the transaction handler (103). In another embodiment, at least some of the profile generator (121), correlator (117), profile selector (129), and advertisement selector (133) are not controlled by the entity that operates the transaction handler (103).

In one embodiment, the products and/or services purchased by the user (101) are also identified by the information transmitted from the merchants or service providers. Thus, the transaction data (109) may include identification of the individual products and/or services, which allows the profile generator (121) to generate transaction profiles (127) with fine granularity or resolution. In one embodiment, the granularity or resolution may be at a level of distinct products and services that can be purchased (e.g., stock-keeping unit (SKU) level), or category or type of products or services, or vendor of products or services, etc.

In one embodiment, the entity operating the transaction handler (103) provides the intelligence information in real time as the request for the intelligence information occurs. In other embodiments, the entity operating the transaction handler (103) may provide the intelligence information in batch mode. The intelligence information can be delivered via online communications (e.g., via an application programming interface (API) on a website, or other information server), or via physical transportation of a computer readable media that stores the data representing the intelligence information.

In one embodiment, the intelligence information is communicated to various entities in the system in a way similar to, and/or in parallel with the information flow in the transaction system to move money. The transaction handler (103) routes the information in the same way it routes the currency involved in the transactions.

In one embodiment, the portal (143) provides a user interface to allow the user (101) to select items offered on different merchant websites and store the selected items in a wish list for comparison, reviewing, purchasing, tracking, etc. The information collected via the wish list can be used to improve the transaction profiles (127) and derive intelligence on the needs of the user (101); and targeted advertisements can be delivered to the user (101) via the wish list user interface provided by the portal (143). Examples of user interface systems to manage wish lists are provided in U.S. Pat. App. Pub. No. 2010/0174623, entitled “System and Method for Managing Items of Interest Selected from Online Merchants,” the disclosure of which is hereby incorporated herein by reference.

### Aggregated Spending Profile

In one embodiment, the characteristics of transaction patterns of customers are profiled via clusters, factors, and/or categories of purchases. The transaction data (109) may include transaction records (301); and in one embodiment, an aggregated spending profile (341) is generated from the transaction records (301), in a way illustrated in FIG. 2, to summarize the spending behavior reflected in the transaction records (301).

In FIG. 2, each of the transaction records (301) is for a particular transaction processed by the transaction handler (103). Each of the transaction records (301) provides information about the particular transaction, such as the account number (302) of the consumer account (146) used to pay for the purchase, the date (303) (and/or time) of the transaction, the amount (304) of the transaction, the ID (305) of the merchant who receives the payment, the category (306) of the merchant, the channel (307) through which the purchase was made, etc. Examples of channels include online, offline in-store, via phone, etc. In one embodiment, the transaction records (301) may further include a field to identify a type of transaction, such as card-present, card-not-present, etc.

A “card-present” transaction typically involves physically presenting the account identification device (141), such as a financial transaction card, to the merchant (e.g., via swiping a credit card at a POS terminal of a merchant); and a “card-not-present” transaction typically involves presenting the account information (142) of the consumer account (146) to the merchant to identify the consumer account (146) without physically presenting the account identification device (141) to the merchant or the transaction terminal (105).

The transaction records (301) of one embodiment may further include details about the products and/or services involved in the purchase.

When there is voluminous data representing the transaction records (301), the spending patterns reflected in the transaction records (301) can be difficult to recognize by an ordinary person.

In FIG. 2, the voluminous transaction records (301) are summarized (335) into aggregated spending profiles (e.g., 341) to concisely present the statistical spending characteristics reflected in the transaction records (301). The aggregated spending profile (341) uses values derived from statistical analysis to present the statistical characteristics of transaction records (301) of an entity in a way easy to understand by an ordinary person.

In FIG. 2, the transaction records (301) are summarized (335) via factor analysis (327) to condense the variables (e.g., 313, 315) and via cluster analysis (329) to segregate entities by spending patterns.

In FIG. 2, a set of variables (e.g., 311, 313, 315) are defined based on the parameters recorded in the transaction records (301). The variables (e.g., 311, 313, and 315) are defined in a way to have meanings easily understood by an ordinary person. For example, variables (311) measure the aggregated spending in super categories; variables (313) measure the spending frequencies in various areas; and variables (315) measure the spending amounts in various areas. In one embodiment, each of the areas is identified by a merchant category (306) (e.g., as represented by a merchant category code (MCC), a North American Industry Classification System (NAICS) code, or a similarly standardized category code). In other embodiments, an area may be identified by a product category, a SKU number, etc.

Examples of the spending frequency variables (313) and spending amount variables (315) defined for various merchant categories (e.g., 306) in one embodiment are provided in U.S. Pat. App. Pub. No. 2010/0306029, entitled “Cardholder Clusters,” and in U.S. Pat. App. Pub. No. 2010/0306032, entitled “Systems and Methods to Summarize Transaction Data,” the disclosures of which applications are hereby incorporated herein by reference.

In FIG. 2, the aggregation (317) includes the application of the definitions (309) for these variables (e.g., 311, 313, and 315) to the transaction records (301) to generate the variable values (321). The transaction records (301) are aggregated to generate aggregated measurements (e.g., variable values (321)) that are not specific to a particular transaction, such as frequencies of purchases made with different merchants or different groups of merchants, the amounts spent with different merchants or different groups of merchants, and the number of unique purchases across different merchants or different groups of merchants, etc. The aggregation (317) can be performed for a particular time period and for entities at various levels.

The transaction records (301) can be aggregated according to a buying entity, or a selling entity. For example, the aggregation (317) can be performed at account level, person level, family level, company level, neighborhood level, city level, region level, etc. to analyze the spending patterns across various areas (e.g., sellers, products or services) for the respective aggregated buying entity. For example, the transaction records (301) for a particular merchant having transactions with multiple accounts can be aggregated for a merchant level analysis. For example, the transaction records (301) for a particular merchant group can be aggregated for a merchant group level analysis. The aggregation (317) can be formed separately for different types of transactions, such as transactions made online, offline, via phone, and/or “card-present” transactions vs. “card-not-present” transactions, which can be used to identify the spending pattern differences among different types of transactions.

In FIG. 2, the variable values (e.g., 323, 324, . . . , 325) associated with an entity ID (322) are considered the random samples of the respective variables (e.g., 311, 313, 315), sampled for the instance of an entity represented by the entity ID (322). Statistical analyses (e.g., factor analysis (327) and cluster analysis (329)) are performed to identify the patterns and correlations in the random samples.

Once the cluster definitions (333) are obtained from the cluster analysis (329), the identity of the cluster (e.g., cluster ID (343)) that contains the entity ID (322) can be used to characterize spending behavior of the entity represented by the entity ID (322). The entities in the same cluster are considered to have similar spending behaviors.

In FIG. 2, the random variables (e.g., 313 and 315) as defined by the definitions (309) have certain degrees of correlation and are not independent from each other. For example, merchants of different merchant categories (e.g., 306) may have overlapping business, or have certain business relationships. For example, certain products and/or services of certain merchants have cause and effect relationships. For example, certain products and/or services of certain merchants are mutually exclusive to a certain degree (e.g., a purchase from one merchant may have a level of probability to exclude the user (101) from making a purchase from another merchant). Such relationships may be complex and difficult to quantify by merely inspecting the categories. Further, such relationships may shift over time as the economy changes.

In FIG. 2, a factor analysis (327) is performed to reduce the redundancy and/or correlation among the variables (e.g., 313, 315). The factor analysis (327) identifies the definitions (331) for factors, each of which represents a combination of the variables (e.g., 313, 315). A factor from the factor analysis (327) is a linear combination of a plurality of the aggregated measurements (e.g., variables (313, 315)) determined for various areas (e.g., merchants or merchant categories, products or product categories). Once the relationship between the factors and the aggregated measurements is determined via factor analysis, the values for the factors can be determined from the linear combinations of the aggregated measurements and be used in a transaction profile (127 or 341) to provide information on the behavior of the entity represented by the entity ID (e.g., an account, an individual, a family).

Once the factor definitions (331) are obtained from the factor analysis (327), the factor definitions (331) can be applied to the variable values (321) to determine factor values (344) for the aggregated spending profile (341). Since redundancy and correlation are reduced in the factors, the number of factors is typically much smaller than the number of the original variables (e.g., 313, 315). Thus, the factor values (344) represent the concise summary of the original variables (e.g., 313, 315).

For example, there may be thousands of variables on spending frequency and amount for different merchant categories; and the factor analysis (327) can reduce the factor number to less than one hundred (and even less than twenty). In one example, a twelve-factor solution is obtained, which allows the use of twelve factors to combine the thousands of the original variables (313, 315); and thus, the spending behavior in thousands of merchant categories can be summarized via twelve factor values (344). In one embodiment, each factor is combination of at least four variables; and a typical variable has contributions to more than one factor.

In FIG. 2, an aggregated spending profile (341) for an entity represented by an entity ID (e.g., 322) includes the cluster ID (343) and factor values (344) determined based on the cluster definitions (333) and the factor definitions (331). The aggregated spending profile (341) may further include other statistical parameters, such as diversity index (342), channel distribution (345), category distribution (346), zip code (347), etc., as further discussed below.

In general, an aggregated spending profile (341) may include more or fewer fields than those illustrated in FIG. 2. For example, in one embodiment, the aggregated spending profile (341) further includes an aggregated spending amount for a period of time (e.g., the past twelve months); in another embodiment, the aggregated spending profile (341) does not include the category distribution (346); and in a further embodiment, the aggregated spending profile (341) may include a set of distance measures to the centroids of the clusters.

FIG. 3 shows a method to generate an aggregated spending profile according to one embodiment. In FIG. 3, computation models are established (351) for variables (e.g., 311, 313, and 315). In one embodiment, the variables are defined in a way to capture certain aspects of the spending statistics, such as frequency, amount, etc.

In FIG. 3, data from related accounts are combined (353); recurrent/installment transactions are combined (355); and account data are selected (357) according to a set of criteria related to activity, consistency, diversity, etc.

In FIG. 3, the computation models (e.g., as represented by the variable definitions (309)) are applied (359) to the remaining account data (e.g., transaction records (301)) to obtain data samples for the variables. The data points associated with the entities, other than those whose transactions fail to meet the minimum requirements for activity, consistency, diversity, etc., are used in factor analysis (327) and cluster analysis (329).

In FIG. 3, the data samples (e.g., variable values (321)) are used to perform (361) factor analysis (327) to identify factor solutions (e.g., factor definitions (331)). The factor solutions can be adjusted (363) to improve similarity in factor values of different sets of transaction data (109).

The data samples can also be used to perform (365) cluster analysis (329) to identify cluster solutions (e.g., cluster definitions (333)). The cluster solutions can be adjusted (367) to improve similarity in cluster identifications based on different sets of transaction data (109). For example, cluster definitions (333) can be applied to the transactions in the time period under analysis (e.g., the past twelve months) and be applied separately to the transactions in a prior time period (e.g., the twelve months before the past twelve months) to obtain two sets of cluster identifications for various entities. The cluster definitions (333) can be adjusted to improve the correlation between the two set of cluster identifications.

Optionally, human understandable characteristics of the factors and clusters are identified (369) to name the factors and clusters. For example, when the spending behavior of a cluster appears to be the behavior of an internet loyalist, the cluster can be named “internet loyalist” such that if a cardholder is found to be in the “internet loyalist” cluster, the spending preferences and patterns of the cardholder can be easily perceived.

In one embodiment, the factor analysis (327) and the cluster analysis (329) are performed periodically (e.g., once a year, or six months) to update the factor definitions (331) and the cluster definitions (333), which may change as the economy and the society change over time.

In FIG. 3, transaction data (109) are summarized (371) using the factor solutions and cluster solutions to generate the aggregated spending profile (341). The aggregated spending profile (341) can be updated more frequently than the factor solutions and cluster solutions, when the new transaction data (109) becomes available. For example, the aggregated spending profile (341) may be updated quarterly or monthly.

Details about aggregated spending profile (341) in one embodiment are provided in U.S. Pat. App. Pub. No. 2010/0306032, entitled “Systems and Methods to Summarize Transaction Data,” the disclosure of which is hereby incorporated herein by reference.

In one embodiment, a set of profiles are generated from the transaction data for a plurality of geographical regions, such as mutually exclusive, non-overlapping regions defined by postal codes. Transactions of account holders residing in the regions are aggregated according to merchant categories for the respective regions and subsequently normalized to obtain preference indicators that reveal the spending preferences of the account holders in the respective regions. Each of the profiles for respective regions is based on a plurality of different account holders and/or households to avoid revealing private information about individual account holders or families. Further, the profiles are constructed in a way to make it impossible to reverse calculate the transaction amounts. Further details and examples about profiles constructed for regions in one embodiment are provided in U.S. Pat. App. Pub. No. 2013/0124263, entitled “Systems and Methods to Summarize Transaction data,” the disclosure of which is hereby incorporated herein by reference.

### Transaction Processing and Data

FIG. 4 shows a system to provide information and/or services based on transaction data (109) according to one embodiment.

In FIG. 4, the transaction handler (103) is coupled between an issuer processor (145) and an acquirer processor (147) to facilitate authorization and settlement of transactions between a consumer account (146) and a merchant account (148). The transaction handler (103) records the transactions in the data warehouse (149). The portal (143) is coupled to the data warehouse (149) to provide information based on the transaction records (301), such as the transaction profiles (127), aggregated spending profile (341), offer redemption notification, etc. The portal (143) may be implemented as a web portal, a telephone gateway, a file/data server, etc.

In FIG. 4, the transaction terminal (105) initiates the transaction for a user (101) (e.g., a customer) for processing by a transaction handler (103). The transaction handler (103) processes the transaction and stores transaction data (109) about the transaction, in connection with account data (111), such as the account profile of an account of the user (101). The account data (111) may further include data about the user (101), collected from issuers or merchants, and/or other sources, such as social networks, credit bureaus, merchant provided information, address information, etc. In one embodiment, a transaction may be initiated by a server (e.g., based on a stored schedule for recurrent payments).

The accumulated transaction data (109) and the corresponding account data (111) are used to generate intelligence information about the purchase behavior, pattern, preference, tendency, frequency, trend, amount and/or propensity of the users (e.g., 101), as individuals or as a member of a group. The intelligence information can then be used to generate, identify and/or select targeted advertisements for presentation to the user (101) on the point of interaction (107), during a transaction, after a transaction, or when other opportunities arise.

In FIG. 4, the consumer account (146) is under the control of the issuer processor (145). The consumer account (146) may be owned by an individual, or an organization such as a business, a school, etc. The consumer account (146) may be a credit account, a debit account, or a stored value account. The issuer may provide the consumer (e.g., user (101)) an account identification device (141) to identify the consumer account (146) using the account information (142). The respective consumer of the account (146) can be called an account holder or a cardholder, even when the consumer is not physically issued a card, or the account identification device (141), in one embodiment. The issuer processor (145) is to charge the consumer account (146) to pay for purchases.

The account identification device (141) of one embodiment is a plastic card having a magnetic strip storing account information (142) identifying the consumer account (146) and/or the issuer processor (145). Alternatively, the account identification device (141) is a smartcard having an integrated circuit chip storing at least the account information (142). The account identification device (141) may optionally include a mobile phone having an integrated smartcard.

The account information (142) may be printed or embossed on the account identification device (141). The account information (142) may be printed as a bar code to allow the transaction terminal (105) to read the information via an optical scanner. The account information (142) may be stored in a memory of the account identification device (141) and configured to be read via wireless, contactless communications, such as near field communications via magnetic field coupling, infrared communications, or radio frequency communications. Alternatively, the transaction terminal (105) may require contact with the account identification device (141) to read the account information (142) (e.g., by reading the magnetic strip of a card with a magnetic strip reader).

The transaction terminal (105) is configured to transmit an authorization request message to the acquirer processor (147). The authorization request includes the account information (142), an amount of payment, and information about the merchant (e.g., an indication of the merchant account (148)). The acquirer processor (147) requests the transaction handler (103) to process the authorization request, based on the account information (142) received in the transaction terminal (105). The transaction handler (103) routes the authorization request to the issuer processor (145) and may process and respond to the authorization request when the issuer processor (145) is not available. The issuer processor (145) determines whether to authorize the transaction based at least in part on a balance of the consumer account (146).

The transaction handler (103), the issuer processor (145), and the acquirer processor (147) may each include a subsystem to identify the risk in the transaction and may reject the transaction based on the risk assessment.

The account identification device (141) may include security features to prevent unauthorized uses of the consumer account (146), such as a logo to show the authenticity of the account identification device (141), encryption to protect the account information (142), etc.

The transaction terminal (105) of one embodiment is configured to interact with the account identification device (141) to obtain the account information (142) that identifies the consumer account (146) and/or the issuer processor (145). The transaction terminal (105) communicates with the acquirer processor (147) that controls the merchant account (148) of a merchant. The transaction terminal (105) may communicate with the acquirer processor (147) via a data communication connection, such as a telephone connection, an Internet connection, etc. The acquirer processor (147) is to collect payments into the merchant account (148) on behalf of the merchant.

In one embodiment, the transaction terminal (105) is a POS terminal at a traditional, offline, “brick and mortar” retail store. In another embodiment, the transaction terminal (105) is an online server that receives account information (142) of the consumer account (146) from the user (101) through a web connection. In one embodiment, the user (101) may provide account information (142) through a telephone call, via verbal communications with a representative of the merchant; and the representative enters the account information (142) into the transaction terminal (105) to initiate the transaction.

In one embodiment, the account information (142) can be entered directly into the transaction terminal (105) to make payment from the consumer account (146), without having to physically present the account identification device (141). When a transaction is initiated without physically presenting an account identification device (141), the transaction is classified as a “card-not-present” (CNP) transaction.

In general, the issuer processor (145) may control more than one consumer account (146); the acquirer processor (147) may control more than one merchant account (148); and the transaction handler (103) is connected between a plurality of issuer processors (e.g., 145) and a plurality of acquirer processors (e.g., 147). An entity (e.g., bank) may operate both an issuer processor (145) and an acquirer processor (147).

In one embodiment, the transaction handler (103), the issuer processor (145), the acquirer processor (147), the transaction terminal (105), the portal (143), and other devices and/or services accessing the portal (143) are connected via communications networks, such as local area networks, cellular telecommunications networks, wireless wide area networks, wireless local area networks, an intranet, and Internet. Dedicated communication channels may be used between the transaction handler (103) and the issuer processor (145), between the transaction handler (103) and the acquirer processor (147), and/or between the portal (143) and the transaction handler (103).

In FIG. 4, the transaction handler (103) uses the data warehouse (149) to store the records about the transactions, such as the transaction records (301) or transaction data (109).

Typically, the transaction handler (103) is implemented using a powerful computer, or cluster of computers functioning as a unit, controlled by instructions stored on a computer readable medium. The transaction handler (103) is configured to support and deliver authorization services, exception file services, and clearing and settlement services. The transaction handler (103) has a subsystem to process authorization requests and another subsystem to perform clearing and settlement services. The transaction handler (103) is configured to process different types of transactions, such credit card transactions, debit card transactions, prepaid card transactions, and other types of commercial transactions. The transaction handler (103) interconnects the issuer processors (e.g., 145) and the acquirer processor (e.g., 147) to facilitate payment communications.

In FIG. 4, the transaction terminal (105) is configured to submit the authorized transactions to the acquirer processor (147) for settlement. The amount for the settlement may be different from the amount specified in the authorization request. The transaction handler (103) is coupled between the issuer processor (145) and the acquirer processor (147) to facilitate the clearing and settling of the transaction. Clearing includes the exchange of financial information between the issuer processor (145) and the acquirer processor (147); and settlement includes the exchange of funds.

In FIG. 4, the issuer processor (145) is configured to provide funds to make payments on behalf of the consumer account (146). The acquirer processor (147) is to receive the funds on behalf of the merchant account (148). The issuer processor (145) and the acquirer processor (147) communicate with the transaction handler (103) to coordinate the transfer of funds for the transaction. The funds can be transferred electronically.

The transaction terminal (105) may submit a transaction directly for settlement, without having to separately submit an authorization request.

In one embodiment, the portal (143) provides a user interface to allow the user (101) to organize the transactions in one or more consumer accounts (146) of the user with one or more issuers. The user (101) may organize the transactions using information and/or categories identified in the transaction records (301), such as merchant category (306), transaction date (303), amount (304), etc. Examples and techniques in one embodiment are provided in U.S. Pat. App. Pub. No. 2007/0055597, entitled “Method and System for Manipulating Purchase Information,” the disclosure of which is hereby incorporated herein by reference.

In one embodiment, the portal (143) provides transaction based statistics, such as indicators for retail spending monitoring, indicators for merchant benchmarking, industry/market segmentation, indicators of spending patterns, etc. Further examples can be found in U.S. Pat. App. Pub. No. 2009/0048884, entitled “Merchant Benchmarking Tool,” the disclosures of which applications are hereby incorporated herein by reference.

### Transaction Terminal

FIG. 5 illustrates a transaction terminal according to one embodiment. The transaction terminal (105) illustrated in FIG. 5 can be used in various systems discussed in connection with other figures of the present disclosure. In FIG. 5, the transaction terminal (105) is configured to interact with an account identification device (141) to obtain account information (142) about the consumer account (146).

In one embodiment, the transaction terminal (105) includes a memory (167) coupled to the processor (151), which controls the operations of a reader (163), an input device (153), an output device (165) and a network interface (161). The memory (167) may store instructions for the processor (151) and/or data, such as an identification that is associated with the merchant account (148).

In one embodiment, the reader (163) includes a magnetic strip reader. In another embodiment, the reader (163) includes a contactless reader, such as a radio frequency identification (RFID) reader, a near field communications (NFC) device configured to read data via magnetic field coupling (in accordance with ISO standard 14443/NFC), a Bluetooth transceiver, a WiFi transceiver, an infrared transceiver, a laser scanner, etc.

In one embodiment, the input device (153) includes key buttons that can be used to enter the account information (142) directly into the transaction terminal (105) without the physical presence of the account identification device (141). The input device (153) can be configured to provide further information to initiate a transaction, such as a personal identification number (PIN), password, zip code, etc. that may be used to access the account identification device (141), or in combination with the account information (142) obtained from the account identification device (141).

In one embodiment, the output device (165) may include a display, a speaker, and/or a printer to present information, such as the result of an authorization request, a receipt for the transaction, an advertisement, etc.

In one embodiment, the network interface (161) is configured to communicate with the acquirer processor (147) via a telephone connection, an Internet connection, or a dedicated data communication channel.

In one embodiment, the instructions stored in the memory (167) are configured at least to cause the transaction terminal (105) to send an authorization request message to the acquirer processor (147) to initiate a transaction. The transaction terminal (105) may or may not send a separate request for the clearing and settling of the transaction. The instructions stored in the memory (167) are also configured to cause the transaction terminal (105) to perform other types of functions discussed in this description.

In one embodiment, a transaction terminal (105) may have fewer components than those illustrated in FIG. 5. For example, in one embodiment, the transaction terminal (105) is configured for “card-not-present” transactions; and the transaction terminal (105) does not have a reader (163).

In one embodiment, a transaction terminal (105) may have more components than those illustrated in FIG. 5. For example, in one embodiment, the transaction terminal (105) is an ATM machine, which includes components to dispense cash under certain conditions.

### Account Identification Device

FIG. 6 illustrates an account identifying device according to one embodiment. In FIG. 6, the account identification device (141) is configured to carry account information (142) that identifies the consumer account (146).

In one embodiment, the account identification device (141) includes a memory (167) coupled to the processor (151), which controls the operations of a communication device (159), an input device (153), an audio device (157) and a display device (155). The memory (167) may store instructions for the processor (151) and/or data, such as the account information (142) associated with the consumer account (146).

In one embodiment, the account information (142) includes an identifier identifying the issuer (and thus the issuer processor (145)) among a plurality of issuers, and an identifier identifying the consumer account among a plurality of consumer accounts controlled by the issuer processor (145). The account information (142) may include an expiration date of the account identification device (141), the name of the consumer holding the consumer account (146), and/or an identifier identifying the account identification device (141) among a plurality of account identification devices associated with the consumer account (146).

In one embodiment, the account information (142) may further include a loyalty program account number, accumulated rewards of the consumer in the loyalty program, an address of the consumer, a balance of the consumer account (146), transit information (e.g., a subway or train pass), access information (e.g., access badges), and/or consumer information (e.g., name, date of birth), etc.

In one embodiment, the memory includes a nonvolatile memory, such as magnetic strip, a memory chip, a flash memory, a Read Only Memory (ROM), etc. to store the account information (142).

In one embodiment, the information stored in the memory (167) of the account identification device (141) may also be in the form of data tracks that are traditionally associated with credits cards. Such tracks include Track 1 and Track 2. Track 1 (“International Air Transport Association”) stores more information than Track 2, and contains the cardholder's name as well as the account number and other discretionary data. Track 1 is sometimes used by airlines when securing reservations with a credit card. Track 2 (“American Banking Association”) is currently most commonly used and is read by ATMs and credit card checkers. The ABA (American Banking Association) designed the specifications of Track 1 and banks abide by it. It contains the cardholder's account number, encrypted PIN, and other discretionary data.

In one embodiment, the communication device (159) includes a semiconductor chip to implement a transceiver for communication with the reader (163) and an antenna to provide and/or receive wireless signals.

In one embodiment, the communication device (159) is configured to communicate with the reader (163). The communication device (159) may include a transmitter to transmit the account information (142) via wireless transmissions, such as radio frequency signals, magnetic coupling, or infrared, Bluetooth or WiFi signals, etc.

In one embodiment, the account identification device (141) is in the form of a mobile phone, personal digital assistant (PDA), etc. The input device (153) can be used to provide input to the processor (151) to control the operation of the account identification device (141); and the audio device (157) and the display device (155) may present status information and/or other information, such as advertisements or offers. The account identification device (141) may include further components that are not shown in FIG. 6, such as a cellular communications subsystem.

In one embodiment, the communication device (159) may access the account information (142) stored on the memory (167) without going through the processor (151).

In one embodiment, the account identification device (141) has fewer components than those illustrated in FIG. 6. For example, an account identification device (141) does not have the input device (153), the audio device (157) and the display device (155) in one embodiment; and in another embodiment, an account identification device (141) does not have components (151-159).

For example, in one embodiment, an account identification device (141) is in the form of a debit card, a credit card, a smartcard, or a consumer device that has optional features such as magnetic strips, or smartcards.

An example of an account identification device (141) is a magnetic strip attached to a plastic substrate in the form of a card. The magnetic strip is used as the memory (167) of the account identification device (141) to provide the account information (142). Consumer information, such as account number, expiration date, and consumer name may be printed or embossed on the card. A semiconductor chip implementing the memory (167) and the communication device (159) may also be embedded in the plastic card to provide account information (142) in one embodiment. In one embodiment, the account identification device (141) has the semiconductor chip but not the magnetic strip.

In one embodiment, the account identification device (141) is integrated with a security device, such as an access card, a radio frequency identification (RFID) tag, a security card, a transponder, etc.

In one embodiment, the account identification device (141) is a handheld and compact device. In one embodiment, the account identification device (141) has a size suitable to be placed in a wallet or pocket of the consumer.

Some examples of an account identification device (141) include a credit card, a debit card, a stored value device, a payment card, a gift card, a smartcard, a smart media card, a payroll card, a health care card, a wrist band, a keychain device, a supermarket discount card, a transponder, and a machine readable medium containing account information (142).

### Point of Interaction

In one embodiment, the point of interaction (107) is to provide an advertisement to the user (101), or to provide information derived from the transaction data (109) to the user (101).

In one embodiment, an advertisement is a marketing interaction which may include an announcement and/or an offer of a benefit, such as a discount, incentive, reward, coupon, gift, cash back, or opportunity (e.g., special ticket/admission). An advertisement may include an offer of a product or service, an announcement of a product or service, or a presentation of a brand of products or services, or a notice of events, facts, opinions, etc. The advertisements can be presented in text, graphics, audio, video, or animation, and as printed matter, web content, interactive media, etc. An advertisement may be presented in response to the presence of a financial transaction card, or in response to a financial transaction card being used to make a financial transaction, or in response to other user activities, such as browsing a web page, submitting a search request, communicating online, entering a wireless communication zone, etc. In one embodiment, the presentation of advertisements may be not a result of a user action.

In one embodiment, the point of interaction (107) can be one of various endpoints of the transaction network, such as point of sale (POS) terminals, automated teller machines (ATMs), electronic kiosks (or computer kiosks or interactive kiosks), self-assist checkout terminals, vending machines, gas pumps, websites of banks (e.g., issuer banks or acquirer banks of credit cards), bank statements (e.g., credit card statements), websites of the transaction handler (103), websites of merchants, checkout websites or web pages for online purchases, etc.

In one embodiment, the point of interaction (107) may be the same as the transaction terminal (105), such as a point of sale (POS) terminal, an automated teller machine (ATM), a mobile phone, a computer of the user for an online transaction, etc. In one embodiment, the point of interaction (107) may be co-located with, or near, the transaction terminal (105) (e.g., a video monitor or display, a digital sign), or produced by the transaction terminal (e.g., a receipt produced by the transaction terminal (105)). In one embodiment, the point of interaction (107) may be separate from and not co-located with the transaction terminal (105), such as a mobile phone, a personal digital assistant, a personal computer of the user, a voice mail box of the user, an email inbox of the user, a digital sign, etc.

For example, the advertisements can be presented on a portion of media for a transaction with the customer, which portion might otherwise be unused and thus referred to as a “white space” herein. A white space can be on a printed matter (e.g., a receipt printed for the transaction, or a printed credit card statement), on a video display (e.g., a display monitor of a POS terminal for a retail transaction, an ATM for cash withdrawal or money transfer, a personal computer of the customer for online purchases), or on an audio channel (e.g., an interactive voice response (IVR) system for a transaction over a telephonic device).

In one embodiment, the white space is part of a media channel available to present a message from the transaction handler (103) in connection with the processing of a transaction of the user (101). In one embodiment, the white space is in a media channel that is used to report information about a transaction of the user (101), such as an authorization status, a confirmation message, a verification message, a user interface to verify a password for the online use of the account information (142), a monthly statement, an alert or a report, or a web page provided by the portal (143) to access a loyalty program associated with the consumer account (146) or a registration program.

In other embodiments, the advertisements can also be presented via other media channels which may not involve a transaction processed by the transaction handler (103). For example, the advertisements can be presented on publications or announcements (e.g., newspapers, magazines, books, directories, radio broadcasts, television, digital signage, etc., which may be in an electronic form, or in a printed or painted form). The advertisements may be presented on paper, on websites, on billboards, on digital signs, or on audio portals.

In one embodiment, the transaction handler (103) purchases the rights to use the media channels from the owner or operators of the media channels and uses the media channels as advertisement spaces. For example, white spaces at a point of interaction (e.g., 107) with customers for transactions processed by the transaction handler (103) can be used to deliver advertisements relevant to the customers conducting the transactions; and the advertisement can be selected based at least in part on the intelligence information derived from the accumulated transaction data (109) and/or the context at the point of interaction (107) and/or the transaction terminal (105).

In general, a point of interaction (e.g., 107) may or may not be capable of receiving inputs from the customers, and may or may not co-located with a transaction terminal (e.g., 105) that initiates the transactions. The white spaces for presenting the advertisement on the point of interaction (107) may be on a portion of a geographical display space (e.g., on a screen), or on a temporal space (e.g., in an audio stream).

In one embodiment, the point of interaction (107) may be used to primarily to access services not provided by the transaction handler (103), such as services provided by a search engine, a social networking website, an online marketplace, a blog, a news site, a television program provider, a radio station, a satellite, a publisher, etc.

In one embodiment, a consumer device is used as the point of interaction (107), which may be a non-portable consumer device or a portable computing device. The consumer device is to provide media content to the user (101) and may receive input from the user (101).

Examples of non-portable consumer devices include a computer terminal, a television set, a personal computer, a set-top box, or the like. Examples of portable consumer devices include a portable computer, a cellular phone, a personal digital assistant (PDA), a pager, a security card, a wireless terminal, or the like. The consumer device may be implemented as a data processing system as illustrated in FIG. 7, with more or fewer components.

In one embodiment, the consumer device includes an account identification device (141). For example, a smart card used as an account identification device (141) is integrated with a mobile phone, or a personal digital assistant (PDA).

In one embodiment, the point of interaction (107) is integrated with a transaction terminal (105). For example, a self-service checkout terminal includes a touch pad to interact with the user (101); and an ATM machine includes a user interface subsystem to interact with the user (101).

### Hardware

In one embodiment, a computing apparatus is configured to include some of the components of systems illustrated in various figures, such as the transaction handler (103), the profile generator (121), the media controller (115), the portal (143), the profile selector (129), the advertisement selector (133), the user tracker (113), the correlator, and their associated storage devices, such as the data warehouse (149).

In one embodiment, at least some of the components such as the transaction handler (103), the transaction terminal (105), the point of interaction (107), the user tracker (113), the media controller (115), the correlator (117), the profile generator (121), the profile selector (129), the advertisement selector (133), the portal (143), the issuer processor (145), the acquirer processor (147), and the account identification device (141), can be implemented as a computer system, such as a data processing system (170) illustrated in FIG. 7. Some of the components may share hardware or be combined on a computer system. In one embodiment, a network of computers can be used to implement one or more of the components.

Further, the data illustrated in the figures, such as transaction data (109), account data (111), transaction profiles (127), and advertisement data (135), can be stored in storage devices of one or more computers accessible to the corresponding components. For example, the transaction data (109) can be stored in the data warehouse (149) that can be implemented as a data processing system illustrated in FIG. 7, with more or fewer components.

In one embodiment, the transaction handler (103) is a payment processing system, or a payment card processor, such as a card processor for credit cards, debit cards, etc.

FIG. 7 illustrates a data processing system according to one embodiment. While FIG. 7 illustrates various components of a computer system, it is not intended to represent any particular architecture or manner of interconnecting the components. One embodiment may use other systems that have fewer or more components than those shown in FIG. 7.

In FIG. 7, the data processing system (170) includes an inter-connect (171) (e.g., bus and system core logic), which interconnects a microprocessor(s) (173) and memory (167). The microprocessor (173) is coupled to cache memory (179) in the example of FIG. 7.

In one embodiment, the inter-connect (171) interconnects the microprocessor(s) (173) and the memory (167) together and also interconnects them to input/output (I/O) device(s) (175) via I/O controller(s) (177). I/O devices (175) may include a display device and/or peripheral devices, such as mice, keyboards, modems, network interfaces, printers, scanners, video cameras and other devices known in the art. In one embodiment, when the data processing system is a server system, some of the I/O devices (175), such as printers, scanners, mice, and/or keyboards, are optional.

In one embodiment, the inter-connect (171) includes one or more buses connected to one another through various bridges, controllers and/or adapters. In one embodiment the I/O controllers (177) include a USB (Universal Serial Bus) adapter for controlling USB peripherals, and/or an IEEE-1394 bus adapter for controlling IEEE-1394 peripherals.

In one embodiment, the memory (167) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### Other Aspects

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer implemented method, comprising:
receiving, in a computing apparatus, travel information of a user of a payment account, the travel information identifying a time period of a travel plan of the user, and a location to be visited in the travel plan of the user;
storing, in the computing apparatus, the travel information of the user in association with the payment account; and
during the time period of the travel plan of the user,
receiving, in the computing apparatus, an authorization request for a payment transaction in the payment account, the payment transaction initiated in a transaction terminal;
determining, by the computing apparatus, whether the transaction terminal is located with a travel region of the user in accordance with the travel information; and
providing, by the computing apparatus, an indicator in the authorization request transmitted to an issuer processor of the payment account, in accordance with a result of the determining, wherein
the indicator has a first state when the transaction terminal is determined to be located within the travel region of the user, and
the indicator has a second state when the transaction terminal is determined to be located outside the travel region of the user.

2. The method of claim 1, wherein the travel information is received in connection with a payment transaction made using the payment account to book the travel plan.

3. The method of claim 2, wherein the travel information is received as part of the payment transaction made using the payment account to book the travel plan.

4. The method of claim 2, wherein the payment transaction made using the payment account to book the travel plan includes a payment for a purchase of an airline flight ticket to the location to be visited in the travel plan of the user.

5. The method of claim 1, wherein the location to be visited in the travel plan of the user is a travel destination; and the method further comprises:
identifying the travel region based on the travel destination specified in the travel information of the user, to determine whether the location of the transaction terminal is in the travel region.

6. The method of claim 5, wherein the travel destination is specified via an identification of an airport for an airline flight ticket purchased using the payment account.

7. The method of claim 6, further comprising:
storing travel information of a plurality of second users;
identifying flights of the second users to the airport;
identifying payment transactions made using payment accounts of the second users during travel time periods following the flights to the airport;
determining locations of transaction terminals that initiated the payment transactions; and
computing a boundary of the travel region for association with the airport based on the locations of the transaction terminals that initiated the payment transactions during the travel time periods of the second users.

8. The method of claim 1, further comprising:
computing a boundary of the travel region based on historical correlation of travel information of a plurality of second users and transaction locations of the second users during respective travels identified by the travel information of the plurality of second users.

9. The method of claim 8, wherein the travel information of the user identifies one or more travel destinations of a travel arrangement purchased using the payment account.

10. The method of claim 9, wherein the travel region is identified based on a destination of the travel arrangement.

11. The method of claim 10, wherein the travel arrangement includes one of:
a ticket for travel;
a lodging reservation; and
a vehicle rental.

12. The method of claim 10, wherein the boundary of the travel region is further based on a time gap between arrival at the destination and payment transaction at the transaction locations.

13. The method of claim 9, further comprising:
storing data associating the payment account with a communication reference; and
in response to an authorization request in a payment transaction in the payment account for the travel arrangement, transmitting a message to the communication reference associated with the payment account, the message identifying the travel arrangement for confirmation and an option regarding adding the indicator in authorization requests made while the user is traveling according to the travel arrangement.

14. The method of claim 13, further comprising:
transmitting to the communication reference a message about the payment transaction initiated at the transaction terminal in the travel region, in parallel with transmitting the authorization request containing the indicator to the issuer processor.

15. The method of claim 1, wherein the computing apparatus includes a transaction handler of a payment processing network having issuer processors and acquirer processors; the receiving the authorization request for the payment transaction in the payment account is performed by the transaction handler; and the providing of the indicator in the authorization request transmitted to the issuer processor of the payment account is performed by the transaction handler.

16. The method of claim 1, further comprising:
determining a travel destination of the travel plan of the user;
determining a time gap between arrival of the user at the travel destination and the authorization request; and
identifying a boundary of the travel region based on the travel destination and the time gap, wherein the determining of whether the transaction terminal is located with the travel region of the user is based on the boundary identified from the travel destination and the time gap.

17. A non-transitory computer-storage medium storing instructions configured to instruct a computing apparatus to at least:
store, in the computing apparatus, travel information of a user in association with a payment account of the user; and
during a travel of the user in accordance with the travel information,
receive, in the computing apparatus, a first authorization request for a payment transaction in the payment account;
identify, by the computing apparatus, a transaction terminal in which the payment transaction is initiated;
determine, by the computing apparatus, a location of the transaction terminal;
determining, by the computing apparatus, a geographical region in which the user is expected to be in accordance with the travel information;
determine, by the computing apparatus, whether the location of the transaction terminal is within the geographical region in which the user is expected to be;
form, by the computing apparatus, a second authorization request based on the first authorization request to include, in the second authorization request, an indicator that:
has a first state when the location of the transaction terminal is within the geographical region, and
has a second state when the location of the transaction terminal is outside the geographical region; and
transmit, by the computing apparatus, the second authorization request to an issuer processor of the payment account, in response to the first authorization request.

18. The computer-storage medium of claim 17, wherein the travel information identifies a location to be visited during the travel of the user; and
wherein the geographical region is determined based on the location visited by the user during the travel of the user.

19. A computing apparatus, comprising:
at least one microprocessor; and
memory storing instructions configured to instruct the at least one microprocessor to perform operations, the operations including:
communicating, by the computing apparatus, with acquirer processors and issuer processors to process payment transactions in a payment processing network;
storing, in the computing apparatus, information about a travel plan of a user of a payment account, in association with the payment account;
during a time period of travel in accordance with the travel plan, receiving, in the computing apparatus, an authorization request for a payment transaction in the payment account;
identifying, by the computing apparatus, a transaction terminal in which the authorization request is initiated;
identifying, by the computing apparatus, a geographical region in which the user is expected to be in accordance with the travel plan;
determining, by the computing apparatus, whether the transaction terminal is located with a geographical region;
generating, by the computing apparatus, an indicator identifying whether or not a location of the payment transaction is consistent with the travel plan of the user; and
forwarding, by the computing apparatus, the authorization request together with the indicator to an issuer processor of the payment account.

20. The computing apparatus of claim 19, wherein the operations further includes:
identifying a boundary of the geographical region based on:
a location visited by the user according to the travel plan;
a time gap between the location visited by the user and the payment transaction; and
a plurality of locations of payment transactions of second users having previously visited the location.
